(19) United States
(12) Patent Application Publication
(10) Pub. No.: US 2026/0248124 A1
(43) Pub. Date: Aug. 27, 2026

(54) PREPARATION CONTAINING BACILLUS VELEZENSIS TCS001 AND USE THEREOF

(71) Applicant: ZHEJIANG A & F UNIVERSITY, Hangzhou, Zhejiang (CN)

(72) Inventors: Jie CHEN, Hangzhou (CN); Feng CUI, Hangzhou (CN); Jing YUAN, Hangzhou (CN); Hao CAO, Hangzhou (CN); Xiaohui HUANG, Hangzhou (CN); Guoqiang SHEN, Hangzhou (CN); Sha ZHOU, Hangzhou (CN); Yuan TANG, Hangzhou (CN)

(73) Assignee: ZHEJIANG A & F UNIVERSITY, Hangzhou, Zhejiang (CN)

(21) Appl. No.: 19/653,580

(22) Filed: Apr. 21, 2026

Related U.S. Application Data
(63) Continuation of application No. PCT/CN2024/130883, filed on Nov. 8, 2024.

(30) Foreign Application Priority Data
Nov. 15, 2023 (CN) 202311517526.2
Nov. 15, 2023 (CN) 202311517527.7
Nov. 15, 2023 (CN) 202311517528.1
Nov. 15, 2023 (CN) 202311517530.9
Nov. 15, 2023 (CN) 202311517532.8

(51) Int. Cl. A01N 25/04; A01N 25/14; A01N 63/22; A01P 3/00; A01P 21/00

(52) U.S. Cl. CPC A01N 25/04; A01N 25/14; A01N 63/22; A01P 3/00; A01P 21/00

(57) ABSTRACT

Disclosed herein is a formulation of a Bacillus velezensis TCS001 suspension concentrate. The suspension concentrate has good dispersibility, a high suspension rate, and relatively strong adhesion to plant surfaces, is resistant to rain erosion, and has more significant and longer-lasting control efficacy than that of wettable powder. Applying the suspension concentrate can improve the quality of cherries and blueberries and promote the growth of strawberries. The suspension concentrate can further serve as an agent for full-growth-cycle disease control and/or quality improvement of cucumbers and tomatoes. After applying the microbial agent throughout the entire crop growth cycle, not only are diseases in facility-cultivated crops effectively controlled, with control efficacy superior to that of conventional chemical agents, but also crop quality and yield are improved compared to the chemical agent treatment group.

### TECHNICAL FIELD

This disclosure relates to the fields of biological strain formulation, crop disease control, and plant growth regulation, and in particular, to a suspension concentrate and a wettable powder formulation containing Bacillus velezensis TCS001, as well as use of the Bacillus velezensis TCS001 suspension concentrate for regulating growth quality of cherries and blueberries, promoting early ripening of blueberries, improving growth traits of strawberries, and achieving full-growth-cycle disease control and quality improvement of cucumbers and tomatoes.

### BACKGROUND

Bacillus velezensis is a novel biocontrol bacterium. In 2005, Spanish scholars Ruiz-Garcia et al. first isolated two strains, CR-14b and CR-502T, which were found to be capable of synthesizing a large amount of lipopeptide substances and exhibit strong antibacterial activity. Bacillus velezensis is widely distributed and can survive under adverse conditions such as drought and salinity. However, there are very few related products, indicating a promising future for its development.

Bacillus velezensis TCS001 was isolated from Bohai Sea silt. The original strain was marine Bacillus CT2628, which was identified and named Bacillus velezensis TCS001 after being stabilized by mutagenesis. It has been deposited at the China General Microbiological Culture Collection Center (CGMCC) with accession number CGMCC No. 8921 and was first disclosed in patent ZL201410168402.2. After growth on an NA medium, single colonies of TCS001 appear nearly circular, pale yellow, and opaque; in the early stage of culture, the colony surface is smooth with neat edges, while in the later stage, the surface becomes wrinkled with slightly irregular edges and a raised center, and the periphery exhibits a cloud-like diffusion. Gram staining showed that Bacillus velezensis TCS001 was Gram-positive and rod-shaped, and exhibited certain inhibitory effects against pathogens causing gray mold, gummy stem blight, Sclerotinia rot, and brown spot in cucumbers, Fusarium wilt in cotton, and leaf spot in bananas, with the highest inhibition rate against cucumber gray mold, reaching 87.66%.

Currently, the registered microbial pesticide formulations on the market include wettable powder (WP), suspension concentrate (SC), flowable concentrate for seed coating (FSC), water dispersible granule (WG), dustable powder (DP), granule (GR), aqueous solution (AS), emulsion in water (EW), and encapsulated granule (CG), among which WP accounts for 66.7%, SC accounts for 8.5%, WG accounts for 5.9%, AS accounts for 1.9%, FSC accounts for 1.3%, GR accounts for 5.2%, DP accounts for 1.3%, CG accounts for 1.3%, and EW accounts for 0.65% (data source: http://www.icama.org.en/hysj/index.jhtml).

Based on the registration data up to now, wettable powder is still the most common formulation of microbial pesticides and fungicides, with other formulations being less common.

Wettable powder is a formulation in which the technical material, inert fillers, and adjuvants are thoroughly mixed in a certain proportion and then pulverized to achieve a certain particle fineness. The laboratory where the inventors of this disclosure work has previously developed a wettable powder containing Bacillus velezensis TCS001. However, the wettable powder has drawbacks such as severe loss of secondary metabolites produced by the strains during the development process, and excessive sedimentation and low suspension rate during use, which may lead to easy clogging of sprayer nozzles, uneven concentration of the spray solution, reduced control efficacy, and increased disease incidence. Therefore, the wettable powder has not been considered as a commercially viable formulation.

The inventors believe that suspension concentrate (SC) accounts for an increasing proportion in the formulations of microbial pesticides, and that environment-friendly formulations represent a new trend in the future development of pesticides. The developed Bacillus velezensis TCS001 suspension concentrate has not yet been applied to cherries or blueberries. Moreover, in the previous research on the control of strawberry gray mold, it was unexpectedly discovered that Bacillus velezensis TCS001 can not only control the disease but also significantly improve the growth traits of strawberries. Based on such findings, this disclosure proposes to use Bacillus velezensis TCS001 as an active ingredient for application in cherries, blueberries, strawberries, tomatoes, and cucumbers, with the aim of reducing the use of chemical pesticides and fertilizers while controlling diseases, improving quality, and increasing yield. This provides a new direction for future research and application.

### SUMMARY

The main purpose of this disclosure is to provide a suspension concentrate formulation containing Bacillus velezensis TCS001, which can meet pesticide registration and commercial application requirements.

In some embodiments, the formulation containing Bacillus velezensis TCS001 comprises SXC and UNA as wetting and dispersing agents.

Preferably, the mass ratio of SXC to UNA is 1:1.

In some embodiments, the formulation containing Bacillus velezensis TCS001 comprises Kathon and sodium benzoate as preservatives.

Preferably, the mass ratio of Kathon to sodium benzoate is 1:3 to 3:1.

In some embodiments, the formulation containing Bacillus velezensis TCS001 comprises xanthan gum as a thickener.

In some embodiments, the formulation containing Bacillus velezensis TCS001 is a suspension concentrate.

Another purpose of this disclosure is to provide a suspension concentrate containing Bacillus velezensis TCS001, including 10-60% of Bacillus velezensis TCS001 fermentation broth, 2-10% of a wetting and dispersing agent, 0.1-1% of a thickener, 0.1-0.5% of a preservative, and water to make up to 100%, where the wetting and dispersing agent is SXC and UNA, and the preservative is Kathon and sodium benzoate.

Preferably, a mass ratio of the Kathon to the sodium benzoate is 1:1.

Preferably, a mass ratio of the SXC to the UNA is 1:1.

Preferably, the thickener is xanthan gum.

Another purpose of this disclosure is to provide a suspension concentrate containing Bacillus velezensis TCS001, including 40% of Bacillus velezensis TCS001 fermentation broth, 3% of wetting and dispersing agent SXC, 3% of wetting and dispersing agent UNA, 0.15% of thickener xanthan gum, 0.2% of preservative Kathon, 0.2% of preservative sodium benzoate, and water to make up to 100%.

Another purpose of this disclosure is to provide a wettable powder containing Bacillus velezensis TCS001, including 70% of Bacillus velezensis TCS001 fermentation broth, 10% of carrier diatomaceous earth, 5% of dispersing agent polyvinyl alcohol, 10% of wetting agent sodium dodecylbenzenesulfonate, 2.5% of stabilizer potassium phosphate, and 2.5% of protectant dextrin.

Another purpose of this disclosure is to provide a method for improving cherry quality using a Bacillus velezensis TCS001 suspension concentrate.

Preferably, the improvement of cherry quality comprises one or more of the following: increasing soluble sugar, increasing soluble solids, increasing anthocyanins, increasing D-carotene, and decreasing acidity.

Preferably, an application concentration of the suspension concentrate is a 300× to 700× dilution.

Preferably, the application concentration of the suspension concentrate is a 400× dilution.

Preferably, a method for applying the Bacillus velezensis TCS001 suspension concentrate is spray treatment.

Preferably, the Bacillus velezensis TCS001 suspension concentrate is applied at one or more of the following cherry growth stages: flower bud differentiation stage, initial flowering stage, full bloom stage, young fruit stage, and harvest stage; and

preferably, the Bacillus velezensis TCS001 suspension concentrate is applied once a week from the young fruit stage to the harvest stage until the end of harvest.

Preferably, the Bacillus velezensis TCS001 suspension concentrate is applied once within 5 days after the end of harvest.

Another purpose of this disclosure is to provide a method for improving blueberry quality using the Bacillus velezensis TCS001 suspension concentrate.

Preferably, the improvement of blueberry quality includes one or more of the following: increasing sugar content and anthocyanins, decreasing acidity, and increasing vitamin C content, color, size, and glossiness of blueberries.

Another main purpose of this disclosure is to provide a method for promoting early ripening of blueberries, including treating the blueberries with the Bacillus velezensis TCS001 suspension concentrate.

Preferably, the blueberries are promoted to ripen 5-7 days earlier.

Preferably, an application concentration of the suspension concentrate is a 300× to 700× dilution.

Preferably, the application concentration of the suspension concentrate is a 500× dilution.

Preferably, a method for applying the Bacillus velezensis TCS001 suspension concentrate is root irrigation and/or spray treatment.

Preferably, the Bacillus velezensis TCS001 suspension concentrate is applied at one or more of the following blueberry growth stages: flower bud differentiation stage, initial flowering stage, full bloom stage, young fruit stage, and harvest stage.

Preferably, the Bacillus velezensis TCS001 suspension concentrate is applied once a week from the young fruit stage to the harvest stage until the end of harvest.

Preferably, the Bacillus velezensis TCS001 suspension concentrate is applied once within 5 days after the end of harvest.

Another purpose of this disclosure is to provide a method for improving growth traits of strawberries using the Bacillus velezensis TCS001 suspension concentrate.

The growth traits of strawberries include leaf chlorophyll concentration, leaves per plant, fresh weight of stems and leaves, fresh weight of roots, leaf area, plant height, leaf indole-3-acetic acid (IAA) content, abscisic acid (ABA) content, superoxide dismutase (SOD) activity, leaf gibberellin (GA) content, catalase (CAT) activity, and peroxidase (POD) activity.

Preferably, an application concentration of the suspension concentrate is a 200× to 500× dilution.

Preferably, the application concentration of the suspension concentrate is a 300× dilution.

Preferably, the Bacillus velezensis TCS001 suspension concentrate is applied at a seedling stage.

Preferably, a method for applying the Bacillus velezensis TCS001 suspension concentrate is root irrigation and/or spray treatment.

A main purpose of this disclosure is to provide use of the Bacillus velezensis TCS001 suspension concentrate for achieving full-growth-cycle control of diseases and improvement of quality traits of facility-cultivated crops, where the facility-cultivated crops are tomatoes and cucumbers;

the diseases include one or more of the following: damping-off, bacterial wilt, early blight, gray mold, and Fusarium wilt in tomatoes, as well as damping-off, bacterial angular leaf spot, powdery mildew, downy mildew, and Fusarium wilt in cucumbers; and

the quality traits include one or more of the following: plant height, stem diameter, average weight per fruit, average yield per plant, soluble solids, vitamin C, soluble sugar, and titratable acid of tomatoes, as well as main stem base circumference, relative chlorophyll content, number of roots, average fruit weight, soluble solids, vitamin C, and moisture content of cucumbers.

Another purpose of this disclosure is to provide a method for improving tomato quality, including applying the Bacillus velezensis TCS001 suspension concentrate during one or more of the following tomato growth stages: seedling raising stage, transplanting day, seedling stage, flowering stage, and fruiting stage.

Another purpose of this disclosure is to provide a method for improving cucumber quality, including applying the Bacillus velezensis TCS001 suspension concentrate during one or more of the following cucumber growth stages: seedling raising stage, transplanting day, planting stage, vining stage, flowering stage, and fruiting stage.

The method of this disclosure further includes applying amino-oligosaccharide during the seedling stage of tomatoes and during the planting and vining stages of cucumbers.

### Beneficial Technical Effects of this Disclosure

To retain the active ingredient such as secondary metabolites of the Bacillus velezensis TCS001 strain, this disclosure selects the Bacillus velezensis TCS001 fermentation broth as the main component to prepare the suspension concentrate, which has better efficacy than wettable powder, does not require organic solvents, has low toxicity and low volatility, is environmentally safe, and has a lower cost.

Since the survival period of Bacillus velezensis TCS001 in the suspension concentrate is short, it cannot meet the needs of practical application. Moreover, its packaging and transportation are inconvenient, and sedimentation and poor fluidity easily occur during its storage. To address the issue of excessively high mortality of viable cells due to environmental problems during storage of the suspension concentrate, this disclosure adds an appropriate and adequate amount of preservatives.

This disclosure, for the first time, selects use of SXC and UNA, Kathon and sodium benzoate, and xanthan gum for formulating a preparation containing Bacillus velezensis TCS001.

Compared with the previous wettable powder, the suspension concentrate of this disclosure has no dust hazard and is relatively safe for operators and the environment. Moreover, the suspension concentrate disperses well in water, can be directly used as a spray solution, has good dispersibility, high suspension rate, and relatively strong adhesion to the plant surface, and is resistant to rain erosion. Therefore, its efficacy is more significant and longer-lasting than that of wettable powder, while also possessing the advantages of wettable powder, being wettable by water, and exhibiting even better suspension after dilution with water.

After treatment with the Bacillus velezensis TCS001 suspension concentrate, the quality of cherry fruits can be significantly improved. After spray treatment with the Bacillus velezensis TCS001 suspension concentrate at a 400× dilution from the cherry flower bud differentiation stage, initial flowering stage, full bloom stage, young fruit stage to harvest stage, compared with CK, β-carotene increased by 13.6%, anthocyanins increased by 9.8%, soluble sugar increased by 7.3%, vitamin C decreased by 19.4%, and total acid decreased by 7%. During the test, it was observed that the cherries after treatment with Bacillus velezensis TCS001 had significantly better size, glossiness, and other traits than the blank control, and exhibited improved organoleptic properties.

After treatment with the Bacillus velezensis TCS001 suspension concentrate, the quality of blueberry fruits could be significantly improved, and it was discovered for the first time that Bacillus velezensis TCS001 could promote early ripening and market availability of blueberry fruits. After root irrigation treatment with the Bacillus velezensis TCS001 suspension concentrate at a 500× dilution, compared with CK, the ripening time was advanced by 5-7 days. After root irrigation treatment with the Bacillus velezensis TCS001 suspension concentrate at a 500× dilution from the blueberry flower bud differentiation stage, initial flowering stage, full bloom stage, young fruit stage to harvest stage, compared with CK, anthocyanins increased by 10%, soluble sugar increased by 4%, vitamin C increased by 5%, and total acid decreased by 20%. During the test, it was observed that the blueberries after treatment with Bacillus velezensis TCS001 had significantly better color, size, glossiness, and other traits than the blank control, and exhibited improved organoleptic properties.

It was discovered for the first time that Bacillus velezensis TCS001 could improve the growth traits of strawberries. After spray treatment with the Bacillus velezensis TCS001 suspension concentrate at a 300× dilution, the chlorophyll concentration in strawberry leaves reached its highest at 14 d and 21 d, increasing by 11% and 14.89% respectively compared with CK, and the number of leaves per plant, fresh weight of stems and leaves, and fresh weight of roots at 28 d increased by 26.5%, 79.4%, and 120% respectively compared with CK. After root irrigation treatment with the Bacillus velezensis TCS001 suspension concentrate at a 300× dilution, compared with CK, the leaf area and plant height of strawberries at 28 d increased by 68.41% and 29.68%, respectively. After root irrigation treatment with the Bacillus velezensis TCS001 suspension concentrate at a 300× dilution, compared with CK, the leaf IAA content, ABA content, and SOD activity of strawberries at 28 d increased by 38.47%, 36.04%, and 21.41%, respectively. After spray treatment with the Bacillus velezensis TCS001 suspension concentrate at a 300× dilution, compared with CK, the leaf GA content, CAT activity, and POD activity of strawberries at 28 d increased by 34.04%, 21.23%, and 23.21%, respectively. Treatment with Bacillus velezensis TCS001 could significantly promote the plant growth of strawberries and induce a faster and stronger protective enzyme system defense response in strawberry leaves.

After applying the Bacillus velezensis TCS001 suspension concentrate throughout the entire growth cycle of facility-cultivated crops, diseases in tomatoes and cucumbers were effectively controlled, with control efficacy superior to that of conventional chemical agents. Meanwhile, crop quality and yield were both improved compared to the conventional chemical agent treatment group. By applying the Bacillus velezensis TCS001 suspension concentrate throughout the entire growth cycle, the purpose of controlling major diseases was achieved, while simultaneously realizing the reduction and efficiency enhancement of chemical pesticides and fertilizers.

### BRIEF DESCRIPTION OF THE DRAWINGS

FIG. 1 shows biocompatibility test results of different types of wetting and dispersing agents with Bacillus velezensis TCS001;

FIG. 2 shows biocompatibility test data of different types of wetting and dispersing agents with Bacillus velezensis TCS001;

FIG. 3 shows biocompatibility test results of different types of thickeners with Bacillus velezensis TCS001;

FIG. 4 shows biocompatibility test results of different types of preservatives with Bacillus velezensis TCS001;

FIG. 5 shows storage stability test data of a Bacillus velezensis TCS001 suspension concentrate of this disclosure at 0° C.;

FIG. 6 shows storage stability test data of the Bacillus velezensis TCS001 suspension concentrate of this disclosure at 4° C.;

FIG. 7 shows storage stability test data of the Bacillus velezensis TCS001 suspension concentrate of this disclosure at room temperature (28° C.);

FIG. 8 shows storage stability test data of the Bacillus velezensis TCS001 suspension concentrate of this disclosure at high temperature (35° C.);

FIG. 9 shows storage stability test data of the Bacillus velezensis TCS001 suspension concentrate of this disclosure at high temperature (45° C.);

FIG. 10 shows storage stability test data of the Bacillus velezensis TCS001 suspension concentrate of this disclosure at high temperature (54° C.);

FIG. 11 shows cherry fruits after treatment with the control and the Bacillus velezensis TCS001 suspension concentrate in a shed;

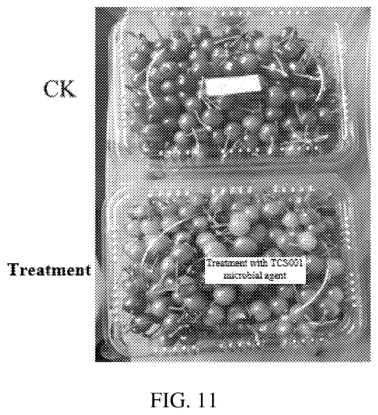

FIG. 12 shows cherry fruits after treatment with the control and the Bacillus velezensis TCS001 suspension concentrate in a shed;

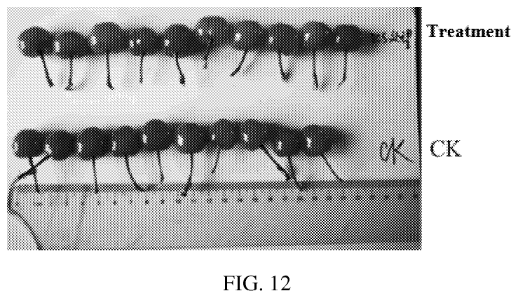

FIG. 13 shows fruits on cherry branches after treatment with the Bacillus velezensis TCS001 suspension concentrate in a shed;

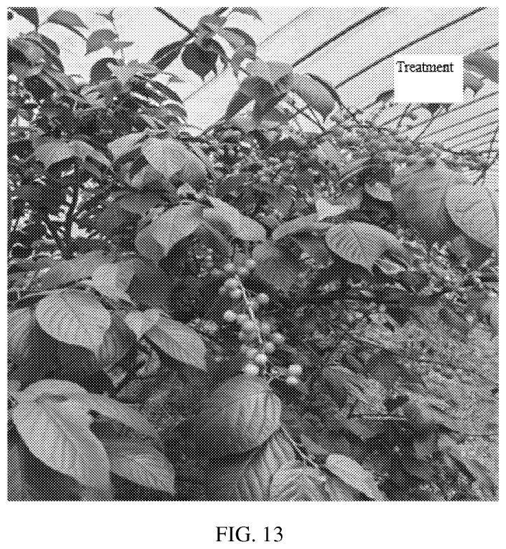

FIG. 14 shows fruits on control cherry branches;

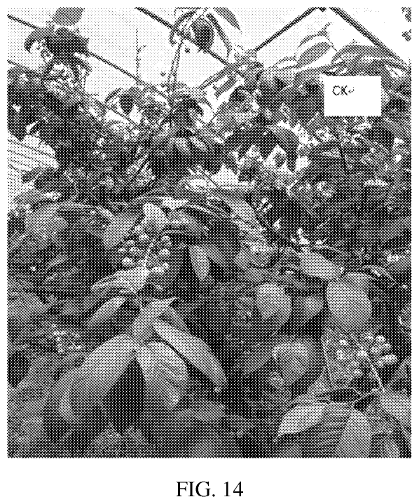

FIG. 15 shows fruits on cherry branches after treatment with the Bacillus velezensis TCS001 suspension concentrate in a shed;

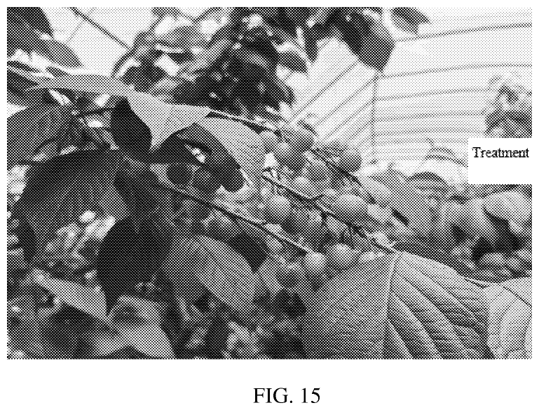

FIG. 16 shows fruits on control cherry branches;

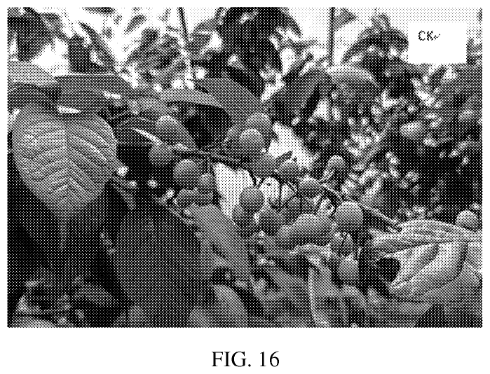

FIG. 17 shows strawberry plants under each treatment of this disclosure;

FIG. 18 shows changes in strawberry chlorophyll content (A), number of leaves per plant (B), plant height (C), fresh weight of stems and leaves (D), fresh weight of roots (E), and leaf area (F) in each treatment group of this disclosure over different time periods;

FIG. 19 shows changes in ABA (A), IAA (B), and GA (C) contents, as well as CAT (D), SOD (E), and POD (F) activities in strawberry leaves of each group after different days of treatment in this disclosure; and

FIG. 20 shows blueberry fruits after treatment with the control group and the Bacillus velezensis TCS001 suspension concentrate applied via root irrigation.

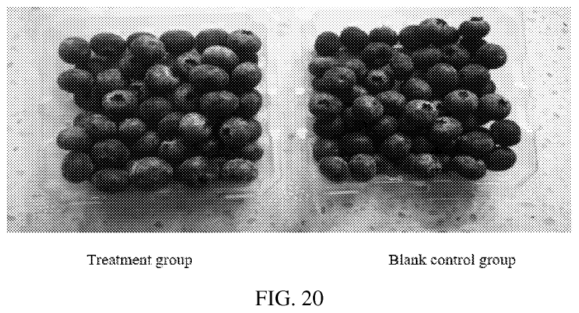

### DETAILED DESCRIPTION OF THE EMBODIMENTS

### Materials and Methods

### Test Materials

Wetting and dispersing agents: SXC, UNA, NN9401, 9160, J401, SP-3060, NS-500LQ, 4913, 33SC, 92FS1, 20TX, SP-2833, and MNS/90;
preservatives: Kathon, sodium benzoate, and S30N; and
thickeners: xanthan gum and magnesium aluminum silicate;
the test microbial agent of this disclosure was Bacillus velezensis TCS001 suspension concentrate (3.9×10⁹ CFU/mL), with the specific formulation being: 40% Bacillus velezensis TCS001 fermentation broth, 3% dispersing agent SXC, 3% dispersing agent UNA, 0.15% thickener xanthan gum, 0.2% preservative Kathon, 0.2% preservative sodium benzoate, 53.45% water (National-Local Joint Engineering Laboratory for Efficient Preparation Technology of Biopesticides, Zhejiang A&F University), 2% amino-oligosaccharide aqueous solution (Shandong Heyi Biological Technology Co., Ltd.), 60% sulfur fenaminosulf wettable powder (Dandong Pesticide General Factory, Liaoning Province), 3% zhongshengmycin wettable powder (Shandong Zhaofengnian Biotechnology Co., Ltd.), 75% chlorothalonil water dispersible granules (Sipcam USA), 40% pyrimethanil wettable powder (Jiangsu Fengdeng Crop Science Co., Ltd.), 66.5% propamocarb hydrochloride aqueous solution (Qingdao Huizhi Biotechnology Co., Ltd.), 6% kasugamycin wettable powder (Shaanxi Tunpsion Biological Technology Co., Ltd.), 5% zhongshengmycin wettable powder (Fujian Kaili Bio-Product Co., Ltd.), 430 g/L tebuconazole suspension concentrate (Zhejiang Qianjiang Biochemical Co., Ltd.), and 40% dimethomorph suspension concentrate (Jiangsu Sword Agrochemical Co., Ltd.).

### Test Plants:

Test Varieties: cherry, Benihoppe strawberry at four-leaf stage, cucumber, tomato, and blueberry (Faxin).

### Main Instruments:

ME104E electronic balance (Sartorius Scientific Instruments Co., Ltd.), chlorophyll meter (Zhejiang Top Cloud-Agri Technology Co., Ltd.), and electric thermostatic blast drying oven (DHG-9023A).

### Methods

The types and concentrations of the above three types of adjuvants were separately screened to obtain an optimal adjuvant formulation for the suspension concentrate, and finally the performance indicators were tested. The wetting and dispersing agents were evaluated by measuring the suspension rate.

### Compatibility of Adjuvants

The biocompatibility of the wetting and dispersing agents, preservatives, and thickeners (four concentrations: 0, 0.1%, 0.3%, and 0.5%) with Bacillus velezensis TCS001 was determined using the toxicity plate method (four concentrations: 0, 1%, 3%, and 5%). For wetting and dispersing agents that were incompatible with LB solid media, the growth amount method was used to determine their biocompatibility with Bacillus velezensis TCS001.

### Screening of Wetting and Dispersing Agents

After determining the appropriate wetting and dispersing agent according to the highest standard of suspension rate and the degree of dispersion through the above method, the test wetting and dispersing agent was added to 100 mL of fermentation broth at different ratios (0, 1%, 3%, and 6%). After standing at room temperature for 24 h, the content of active ingredient in the suspension was determined by the CFU method. The grade was determined according to the dispersion state based on Table 1, and the optimal amount of the wetting and dispersing agent was determined.

TABLE 1
Classification Standards for Dispersion Performance

| Dispersion State | Grade |
|---|---|
| The wetting and dispersing agent automatically disperses | Excellent |
| in a cloud-like manner | |
| The wetting and dispersing agent substantially disperses | Good |
| with sinking particles | |
| The wetting and dispersing agent requires shaking to | Moderate |
| disperse | |
| The wetting and dispersing agent flocculates and sinks, | Poor |
| cannot disperse automatically, and requires vigorous shaking | |

### Screening of Thickener Amount

Different concentrations (0, 0.05%, 0.1%, 0.15%, 0.2%, and 0.25%) of thickener were added to the fermentation broth containing the wetting and dispersing agent; the water separation rate and viscosity were observed at room temperature after one month; 8 mL of the fermentation broth was added to a 10 mL centrifuge tube and centrifuged at a low speed at room temperature for half an hour, and then the sedimentation was closely observed; 1 mL of the supernatant after centrifugation was taken to determine its CFU content, thereby determining the appropriate amount of thickener.

### Screening of Preservatives

During storage, the suspension concentrate must be protected from contamination by other bacteria, so a small amount of preservative needs to be added. The type and concentration of the preservative were determined through a biocompatibility test. Using the adjuvants selected in the test, different concentrations (0, 0.1%, 0.2%, and 0.3%) of preservatives were added to prepare different samples. After storing the samples at room temperature for 14 days, their suspension rate and moldiness were measured.

Method for Determining the Content of Bacillus velezensis

### Preparation of Dilution Solution

2 mL of Tween 80, 18 g of NaCl, and 2,000 mL of distilled water were heated to fully dissolve, and then dispensed into a conical flask and sterilized at 121° C. for 30 min.

### Dilution of the Sample (Determination of Viable Cell Count)

Under aseptic conditions, 1.0 mL of the sample (accurate to 0.01 mL) was accurately pipetted using a pipette, and then placed into 9.0 mL of the dilution solution and mixed well to obtain a 10× diluted sample solution, labeled as No. 0. Then, gradient dilution was performed according to Table 2. (To reduce sample dilution errors, during serial dilution, each dilution solution should be shaken thoroughly to ensure uniformity. Additionally, a new pipette tip should be used for each dilution step. When the bacterial solution is transferred from the previous gradient to the next using a pipette, it should be introduced along the tube wall and shaken by hand for 30 s to ensure uniform dilution.)

TABLE 2
Gradient Dilution

| No. | 0 | 1 | 2 | 3 | 4 | 5 | 6 | 7 | 8 |
|---|---|---|---|---|---|---|---|---|---|
| Volume of Sterile Water | 9.0 | 9.0 | 9.0 | 9.0 | 9.0 | 9.0 | 9.0 | 9.0 | 9.0 |
| (mL) | | | | | | | | | |
| Volume of Solution from | — | 1.0 | 1.0 | 1.0 | 1.0 | 1.0 | 1.0 | 1.0 | 1.0 |
| Previous Dilution | | | | | | | | | |
| Concentration Added (mL) | | | | | | | | | |
| Cumulative Dilution | 10 | 10² | 10³ | 10⁴ | 10⁵ | 10⁶ | 10⁷ | 10⁸ | 10⁹ |
| Factor | | | | | | | | | |

### Dilution of the Sample (Determination of Spore Count)

The test sample was ultrasonicated in an ultrasonic water bath for 10 min, and 5.0 mL of the sample was transferred into a conical flask containing 45 mL of dilution solution and then shaken thoroughly on a shaker at 200 r/min for 30 min to obtain a 1:10 bacterial suspension; next, the 1:10 bacterial suspension was placed in a water bath at 80° C.±1° C. for 10 min; after cooling, gradient dilution was performed according to Table 2.

### Plate Coating and Counting (Viable Cell Count and Spore Count)

Under aseptic conditions, sterilized LB medium was poured into culture dishes and cooled to room temperature.

100 L of each of the three gradient dilution solutions (Nos. 6, 7, and 8 above) were pipetted onto LB plates, and spread evenly over the entire plate surface using a bent glass rod. Three replicates were performed for each dilution gradient. The plates were then placed in a constant-temperature incubator under dark conditions at 28° C. for 48 h of cultivation.

### pH Determination

1.0 g of the sample was weighed into a 100 mL beaker, and 100 mL of water was added, followed by vigorous stirring for 1 min. The mixture was allowed to stand for 1 min. The rinsed glass electrode and saturated calomel electrode were inserted into the sample solution, and the pH value was measured. At least three parallel determinations were performed. The absolute difference between the determination results was less than 0.1, and the arithmetic mean was taken as the pH value of the sample.

### Determination of Suspension Rate

The specific operation procedure was as follows: 1 mL of the uniformly mixed product was taken into a graduated cylinder containing 249 mL of standard hard water. Using the middle of the graduated cylinder as the axis, it was continuously inverted up and down, and then treated in a constant-temperature water bath at 30° C. for 30 min. Subsequently, the top 9/10 of the liquid in the graduated cylinder was aspirated using a pipette, and the CFU of the remaining suspension was determined.

The suspension rate was calculated according to the following formula:

$${W}_{1} ( \% ) = [ ( {M}_{1} - {M}_{2} ) / {M}_{1} ] \times 10 / 9 \times 100$$

where
M₁—total number of Bacillus bacteria in the sample taken to prepare the suspension, in units of cells;
M₂—total number of bacteria in the corresponding bottom suspension, in units of cells; and
10/9—conversion coefficient.

### Determination of Persistent Foaming Property

Standard hard water (15° C.-25° C.) was added to a graduated cylinder up to the 180 mL mark; the graduated cylinder was placed on a balance, and 1.0 g of the sample was weighed into it; hard water was added up to the mark that was 9 cm±0.1 cm from the bottom of the cylinder stopper, and the graduated cylinder was stoppered and, taking the middle of the graduated cylinder as the center, inverted 1800 up and down 30 times (2 s per inversion). The graduated cylinder was placed vertically on a test bench and allowed to stand; the foam volume (accurate to 2 mL) at 1 min 10 s was recorded; the measurement was repeated three times, and the arithmetic mean was taken as the persistent foaming property determination result for the sample.

### Determination of Suspension Concentrate Pourability

Determination of Residue after Pouring

The mass of the graduated cylinder with a stopper was weighed (accurate to 0.1 g); the sample was added up to 80% of the total volume mark of the graduated cylinder; and the graduated cylinder was stoppered and weighed again (accurate to 0.1 g). After standing at room temperature (the specific temperature could be determined according to actual needs) for 24 h, the graduated cylinder was first rotated 1350 from the upright position, poured for 60 s, and then inverted for 60 s. The mass of the graduated cylinder with a stopper was weighed again (accurate to 0.1 g). The residue after pouring of the sample, expressed as a mass fraction, was calculated by formula (1):

where

$${W}_{1} = \frac{M 2 - M 0}{M 1 - M 0} \times 100 \% \qquad ( 1 )$$

W₁—residue after pouring, expressed as %;
M₂—total mass of the residue after pouring and the graduated cylinder with a stopper, in grams (g);
M₀—mass of the graduated cylinder with a stopper, in grams (g); and
M₁—total mass of the sample and the graduated cylinder with a stopper, in grams (g);
   Determination of Residue after Washing

Distilled water at 20° C. was added up to 80% of the total volume mark of the graduated cylinder, and the graduated cylinder was stoppered and inverted 10 times (when the graduated cylinder was inverted, it was ensured that each inversion centered on the middle of the graduated cylinder, taking approximately 2 s to complete the motion from an upright state to a 1800 inverted state and back to the original state, and the operation was performed smoothly and uniformly). Water was then poured out using the same method as for pouring, and the graduated cylinder was weighed again with the stopper (accurate to 0.1 g). The residue after washing of the sample, expressed as a mass fraction, was calculated by formula (2):

$${W}_{2} = \frac{M 3 - M 0}{M 1 - M 0} \times 100 \% \qquad ( 2 )$$

W₂—residue after washing, expressed as %;
M₃—total mass of the residue after washing and the graduated cylinder with a stopper, in grams (g);
M₀—mass of the graduated cylinder with a stopper, in grams (g);
M₁—total mass of the sample and the graduated cylinder with a stopper, in grams (g);

### Determination by Wet Sieving

The finished Bacillus velezensis suspension concentrate was passed through a 75 μm standard sieve. The measurement was repeated three times, and the average value was taken.

### Determination of Contamination Rate

The number of bacterial colonies growing on a PDA plate was the total bacterial count in the sample. Whether the bacteria were typical Bacillus velezensis was determined based on colony morphology and microscopic observation. The ratio of contaminating bacteria to the total bacterial count was the contamination rate of the product.

Bacteria with morphology inconsistent with typical colonies were considered as contaminating bacteria, and morphological observation and verification were performed on suspicious colonies. The contaminating bacterial colony count B (in CFU/mL) of the sample was calculated by formula (2), and the contamination rate X (%) was calculated by formula (3):

$$B = \frac{c}{0.1} \times n \qquad ( 2 )$$

where
c—average number of colonies that were not Bacillus velezensis TCS001 on the plate, in CFU;
0.1—sample volume taken for coating the plate, in mL; and
n—dilution factor of the sample.

$$X = \frac{B}{B + A} \times 100 \qquad ( 3 )$$

where
B—number of contaminating bacteria per mL of sample, in CFU/mL; and
A—number of typical Bacillus velezensis TCS001 colonies per mL of sample, in CFU/mL.

### Determination of Storage Stability

### Determination of Low-Temperature (0±2° C.) Storage Stability

The low-temperature stability of the Bacillus velezensis TCS001 suspension concentrate was determined for a period of 2 weeks. The TCS001 suspension concentrate sample was stored in an environment at 0±2° C. After 2 weeks of storage, the content of active ingredient, i.e., viable cell count and spore count, was determined by the dilution plating method.

### Determination of Low-Temperature (4±2° C.) Storage Stability

The low-temperature stability of the Bacillus velezensis TCS001 suspension concentrate was determined for a period of 2 years. The TCS001 suspension concentrate sample was stored in an environment at 4±2° C. The content of active ingredient, i.e., viable cell count and spore count, was determined every 3 months by the dilution plating method.

### Determination of Room-Temperature (28±2° C.) Storage Stability

The room-temperature stability of the Bacillus velezensis TCS001 suspension concentrate was determined for a period of 1 year. The TCS001 suspension concentrate sample was stored in an environment at 28±2° C. The content of active ingredient, i.e., viable cell count and spore count, was determined every 1 month by the dilution plating method.

### Determination of High-Temperature (54±2° C.) Storage Stability

The high-temperature stability of the Bacillus velezensis TCS001 suspension concentrate was determined for a period of 2 weeks. The TCS001 suspension concentrate sample was stored in an environment at 54±2° C. After 2 weeks of storage, the content of active ingredient, i.e., viable cell count and spore count, was determined by the dilution plating method.

### Determination of High-Temperature (45±2° C.) Storage Stability

The high-temperature stability of the Bacillus velezensis TCS001 suspension concentrate was determined for a period of 6 weeks. The TCS001 suspension concentrate sample was stored in an environment at 45±2° C. The content of active ingredient, i.e., viable cell count and spore count, was determined every 3 weeks by the dilution plating method.

### Determination of High-Temperature (35±2° C.) Storage Stability

The high-temperature stability of the Bacillus velezensis TCS001 suspension concentrate was determined for a period of 12 weeks. The TCS001 suspension concentrate sample was stored in an environment at 35±2° C. The content of active ingredient, i.e., viable cell count and spore count, was determined every 3 weeks by the dilution plating method.

Methods for Treating Cherries and Blueberries with the Bacillus velezensis TCS001 Suspension Concentrate

TABLE 3
Methods for Treating Cherries with the Bacillus velezensis
TCS001 Suspension Concentrate

| Treatment | | |
|---|---|---|
| Method | Reagent Dilution | Treatment Frequency |
| Spray | TCS001 suspension | Once each at differentiation stage, |
| | concentrate | initial flowering stage, and full bloom |
| | 400x dilution | stage, totaling 3 times |
| Spray | TCS001 suspension | Once per week from young fruit stage |
| | concentrate | to harvest stage, totaling 5 times |
| | 400x dilution | |
| Spray | TCS001 suspension | |
| | concentrate | Root irrigation once 5 days after harvest |
| | 400x dilution | |
| CK | | |

The Bacillus velezensis TCS001 suspension concentrate was diluted with water to the corresponding concentration, and then spray treatments were performed respectively.

Spray treatment: one spray treatment was performed at the cherry flower bud differentiation stage, initial flowering stage, and full bloom stage, respectively, and continuous spray treatment was performed once per week from the young fruit stage to the harvest stage.

TABLE 4
Methods for Treating Blueberries with the Bacillus velezensis
TCS001 Suspension Concentrate

| Treatment | | |
|---|---|---|
| Method | Reagent Dilution | Treatment Frequency |
| Root | TCS001 suspension | Once each at differentiation stage, |
| irrigation | concentrate | initial flowering stage, and full bloom |
| | 500x dilution | stage, totaling 3 times |
| Root | TCS001 suspension | Once per week from young fruit stage |
| irrigation | concentrate | to harvest stage, totaling 5 times |
| | 500x dilution | |
| Root | TCS001 suspension | |
| irrigation | concentrate | Root irrigation once 5 days after harvest |
| | 500x dilution | |
| CK | | |

The Bacillus velezensis TCS001 suspension concentrate was diluted with water to the corresponding concentration, and then root irrigation treatments were performed respectively. Each blueberry tree was irrigated with 500 mL of the solution.

Root irrigation: one root irrigation treatment was performed at the blueberry flower bud differentiation stage, initial flowering stage, and full bloom stage, respectively, and one root irrigation treatment was performed once per week from the young fruit stage to the harvest stage.

### Determination of Quality Indicators of Cherries and Blueberries

### Method for Determining Soluble Sugar: NY/T 2742-2015

1. Preparation of raw material: the fruits were washed and wiped dry, and the edible part was taken, chopped, and mixed evenly. A quartering method was used for sampling, and a homogenate was prepared using a tissue homogenizer (juicy fruits were directly homogenized; for fruits with low moisture content, water was added in a 1+1 ratio before homogenization). 10.00 g (m) of the sample was weighed and washed into a volumetric flask with water, and 3 mL each of potassium ferrocyanide solution (4.5) and zinc acetate solution (4.6) were added. The mixture was shaken well, diluted to 250 mL (V1), allowed to stand for a while, and filtered, and the filtrate was set aside for use.
2. Preparation of standard curve: 0 mL, 0.2 mL, 0.4 mL, 0.8 mL, 1.0 mL, and 1.2 mL of glucose standard solution were accurately pipetted into six 10 mL graduated test tubes with stoppers, water was added to bring the solution volume to 2.0 mL, 400 mL of 3,5-dinitrosalicylic acid reagent was added, and the tubes were heated in a boiling water bath for 5 min. After removal, they were immediately placed in cold water, cooled to room temperature, diluted to volume, and shaken well. The concentrations of the resulting series of glucose standard solutions were 0 mg/mL, 0.02 mg/mL, 0.04 mg/mL, 0.08 mg/mL, 0.10 mg/mL, and 0.12 mg/mL, respectively. The absorbance at 540 nm was measured using a spectrophotometer. A standard curve was plotted with the glucose concentration (mg/mL) as the ordinate (y) and the absorbance value as the abscissa (x).
3. Determination of reducing sugar: depending on the sugar content in different samples, 5 mL to 20 mL (V2) of the filtrate was pipetted into a volumetric flask and diluted to 100 mL (V3) with water. 1.0 mL (V4) of the sample solution was pipetted from the volumetric flask into a 10 mL (V5) volumetric flask or graduated test tube with a stopper, and water was added to each to reach 2.0 mL. The subsequent steps were performed according to the procedure for the standard curve described above. The measured absorbance value was recorded, and the concentration of reducing sugar in the test solution was obtained from the standard curve.
4. Determination of soluble sugar: depending on the sugar content of the sample, 5 mL to 10 mL (V2) of the sample solution was pipetted into a volumetric flask, 1 mL of 6 mol/L hydrochloric acid solution was added, and the flask was heated in a constant-temperature water bath at (80±2°) C for 10 min. After removal, it was cooled to room temperature in a cold water bath, 3 drops of methyl red indicator were added, and the solution was neutralized with 6 mol/L sodium hydroxide solution until the color turned light orange. Water was added to dilute to 100 mL (V3), and the mixture was shaken well. The subsequent steps were performed according to the procedure for the determination of reducing sugar. The soluble sugar content in the sample, expressed as a mass fraction, was calculated by the following formula:

$$X = \frac{P * V 1 * V 3 * V 5 * A}{m * V 2 * V 4 * 10}$$

where
X: soluble sugar content in the sample, expressed as %;
P: concentration of reducing sugar in the test solution of the sample, expressed in mg/mL;
V1: dilution volume of the sample solution, expressed in mL;
V2: aliquot volume of the sample solution taken, expressed in mL;
V3: dilution volume of the aliquot sample solution, expressed in mL
V4: volume of the test solution taken, expressed in mL;
V5: volume of the sample solution for measurement, expressed in mL;
A: dilution factor, which is 1 for juicy fruits and 2 for fruits with low moisture content;
m: mass of the sample, expressed in g; and
10: conversion factor for converting the measurement result to mass percentage.

### Method for Determining Total Acid: GB 12456-2021

The determination of titratable acidity was performed as follows:
1. Preparation of raw material: the edible part was taken using the quartering method, chopped, and mixed evenly; 250 g of the edible part was weighed, accurate to 0.1 g, and placed in a high-speed tissue homogenizer; an equal amount of water was added, homogenization was performed for 1 to 2 min, and 2 g of the homogenate was calculated as 1 g of sample; 50 g of the homogenate was weighed, accurate to 0.1 g, and washed with 100 mL of water into a 250 mL volumetric flask; the flask was heated in a water bath at 75° C. to 80° C. for 30 min, shaken several times during heating, and then removed and cooled. Water was added to the mark, and the mixture was shaken and filtered.
2. Indicator titration method: based on the predicted acidity, 50 mL of the sample solution was pipetted, 5 drops of phenolphthalein indicator were added, and the solution was titrated with sodium hydroxide standard solution. The endpoint was reached when a slight red color appeared and did not fade within 30 s. The volume consumed was recorded.

The determination result was calculated by the following formula:

$$Titratable acid ( mmol / 100 g ) = \frac{C * V 1}{50} \times \frac{250}{m ( V )} \times 100$$

where
V1: volume of the sodium hydroxide standard solution consumed during titration, in mL;
C: molar concentration of the sodium hydroxide standard solution, in mol/L;
m: mass of the sample, in g; and
250: dilution volume after sample extraction, in mL.

### Determination of Soluble Solids: NY/T 2637-2014

Determination was performed by the refractometer method as follows:
1. Preparation of sample solution: blueberries and cherries were chopped and mixed evenly; an appropriate amount of sample (generally, 250 g for samples with high moisture content and 125 g for samples with low moisture content) was weighed; an appropriate amount of water was added, and the mixture was comminuted in a high-speed tissue homogenizer. The homogenized juice was squeezed out using two layers of lens paper or four layers of gauze for determination.
2. Instrument calibration: at 20° C., the refractometer was calibrated using distilled water, and the reading of the soluble solids content was adjusted to 0.
3. Determination of sample solution: the determination temperature was kept stable, with a variation not exceeding ±0.5° C. The prism surface was cleaned with a soft flannel cloth; 2 to 3 drops of the test sample solution were added, allowing the sample solution to spread evenly over the entire prism surface; the light source was aligned (for non-digital refractometers, the achromatic adjustment knob was rotated to divide the field of view into light and dark portions, and then the prism knob was rotated to bring the light-dark boundary line exactly to the crosshairs of the objective lens), and the refractometer reading was recorded. For refractometers without automatic temperature compensation, the determination temperature was recorded. The prism surface was cleaned with distilled water and a soft flannel cloth.
4. Result calculation: for undiluted samples, the refractometer reading was the soluble solids content in the sample. For samples diluted with distilled water, the soluble solids content was calculated according to the formula.

The determination result was calculated by the following formula:

$$X = P \times \frac{{m}_{0} + {m}_{1}}{m 0}$$

where
X: soluble solids content in the sample, expressed as percentage (%);
P: soluble solids content in the sample solution, expressed as percentage (%);
m₀: mass of the sample, expressed in grams (g); and
m₁: mass of distilled water added to the sample, expressed in grams (g).

### Method for Determining Vitamin C (Ascorbic Acid): GB 5009.86-2016

### Determination of Vitamin C (Ascorbic Acid)

1. Preparation of sample solution: 10 g of the slurry sample was weighed; the sample was transferred into a 100 mL volumetric flask using an extracting agent, diluted to the mark, shaken well, and filtered. If the filtrate was colored, decolorization was performed by adding 0.4 g of kaolin per gram of sample before filtration.
2. Titration: an appropriate amount of the filtrate was pipetted into a 50 mL conical flask and titrated with a standardized 2,6-dichlorophenolindophenol solution until the solution turned pink and did not fade for 15 s. A blank test was performed simultaneously. Vitamin C content was calculated by the following formula:

$$ϖ ( mg / 100 g ) = \frac{( {V}_{1} - {V}_{0} ) \times T \times f}{m} \times 100$$

where
V₁: volume of dye solution consumed during titration of the sample (mL);
V₀: volume of dye solution consumed during titration of the blank (mL);
T: titer of the 2,6-dichlorophenolindophenol dye (mg/mL);
F: dilution factor; and
M: weight of the sample (g).

### Method for Determining Anthocyanins: T/QAS 075-2022

### Determination of Anthocyanins:

1. Preparation of raw material: an appropriate amount was taken by the quartering method, or the whole was taken; after removing impurities such as visible branches, leaves, and crushed fruits except the fruit and stem, the sample was homogenized and dispersed using a homogenizer at 15,000 r/min for 20 s to prepare a homogenate; the homogenate was immediately used for testing. The entire testing process was conducted under light-protected conditions.
2. 5.0 g of the fresh fruit homogenate, accurate to ±1 mg, or 0.1 g of the extract, accurate to ±0.1 mg, was weighed and placed in a 150 mL ground-glass conical flask with a stopper; 50 mL of extraction solution (concentrated HCl:80% ethanol solution=3:97, v/v) was accurately added; the flask was stoppered and weighed. The flask was placed in an ultrasonic cleaner for ultrasonic extraction at 50° C. for 30 min, and shaken once every 10 min to maintain complete dispersion of the solid phase. After extraction, the flask was cooled to room temperature and weighed again, and the lost weight was compensated with the extraction solution, followed by uniform mixing. Part of the extraction solution was centrifuged at 8,000 r/min for 3 min, and the supernatant was collected for use.
3. The prepared test solution was first 2×- to 10×-diluted with the extraction solution (concentrated hydrochloric acid: 80% ethanol solution=3:97, v/v) (containing 5 mg to 60 mg of anthocyanins), and then further 5×-diluted with buffer solution to prepare two test sample solutions. One portion was diluted with potassium chloride buffer solution (0.025 mol/L, pH 1.0) (1 mL test solution+4 mL potassium chloride buffer solution), and the other portion was diluted with sodium acetate buffer solution (0.4 mol/L, pH 4.5) (1 mL test solution+4 mL sodium acetate buffer solution).
4. After the test sample solutions were allowed to stand for 10 min, partial visible band scanning was performed between 400 nm and 600 nm to determine the maximum absorption wavelength. The absorbance values of the test sample solution diluted with pH 1.0 buffer and the test sample solution diluted with pH 4.5 buffer were measured at the maximum absorption wavelength and at 700 nm, respectively.

The content X of anthocyanins (calculated as petunidin-based components) was calculated by the following formula:

$$X = \frac{A \times M W \times D F \times V}{ε \times 1 \times m \times 10}$$

where
X: content of anthocyanins in cherries calculated as petunidin-based components, expressed in grams per hundred grams (g/100 g);
A: difference in absorbance between the test sample solutions at pH 1.0 and pH 4.5, A=(Amax nm−A700 nm) pH1.0−(Amax nm−A700 nm) pH4.5;
MW: 912.7, average molar mass of petunidin-based components, expressed in grams per mole (g/mol);
DF: dilution factor;
V: total volume of the extraction solution, expressed in milliliters (mL);
E: 29591, average molar extinction coefficient of petunidin-based components, expressed in liters per mole centimeter (L/(mol cm));
l: cuvette path length, expressed in centimeters (cm);
m: mass of the sample taken, expressed in grams (g); and
10: conversion factor for converting from g/kg to g/100 g.

### Method for Determining β-Carotene in Cherries: GB 5009.83-2016

Determination by reversed-phase chromatography was performed as follows:
1. Preparation of raw material: 1-5 g (accurate to 0.001 g) of the uniformly mixed sample was accurately weighed and transferred to a 250 mL conical flask; 1 g of ascorbic acid and 75 mL of anhydrous ethanol were added, and the flask was shaken in a water bath at 60° C. 1° C. for 30 min.
2. Saponification: 25 mL of potassium hydroxide solution was added, and the flask was stoppered. The flask was placed in a constant-temperature shaking water bath preheated to 53° C.±2° C. for saponification for 30 min. Then, the flask was removed, allowed to stand, and cooled to room temperature.
3. Sample extraction: the saponified solution was transferred to a 500 mL separatory funnel; 100 mL of petroleum ether was added, gently shaken to release gases, stoppered, and shaken at room temperature for 10 min; after standing for phase separation, the aqueous phase was transferred to another separatory funnel for a second extraction following the same method. The organic phases were combined and washed with water until nearly neutral. The aqueous phase was discarded, and the organic phase was dehydrated by filtration through anhydrous sodium sulfate. The filtrate was collected in a 500 mL evaporation flask and concentrated under reduced pressure at 40° C.±2° C. on a rotary evaporator until nearly dry. The residue was dried under nitrogen; 5.0 mL of dichloromethane was accurately added using a pipette; the flask was stoppered; and the extract was fully dissolved. After filtration through a 0.45 m membrane, the initial approximately 1 mL of filtrate was discarded, and the remainder was collected into a sample vial for use.
4. Sample determination: under the same chromatographic conditions, the test sample solution was injected into the liquid chromatograph for HPLC analysis; qualitative identification was performed based on retention time, and quantification was performed using the external standard method based on peak area; the concentration of D-carotene in the test solution was calculated according to the standard curve regression equation.

The determination result was calculated by the following formula:

$$β - Carotene ( μ g / 100 g ) = \frac{ρβ \times V \times 100}{m}$$

where
ρβ: concentration 2 of β-carotene in the test solution obtained from the standard curve, expressed in g/mL;
V: dilution volume of the test sample solution, expressed in mL;
100: coefficient to express the result as g/100 g; and
m: mass of the sample, expressed in g.
   Test Method for Promoting Strawberry Growth with the Bacillus velezensis TCS001 Suspension Concentrate

TABLE 5
Methods for Treating Strawberry Pots with the
Bacillus velezensis TCS001 Suspension Concentrate

| | | Treatment |
|---|---|---|
| Treatment | Reagent Dilution | Frequency |
| Method | TCS001 suspension concentrate | 1, 2, 3 |
| Spray | 300x dilution | |
| Root | TCS001 suspension concentrate | 1, 2, 3 |
| irrigation | 300x dilution | |
| CK | | |

The Bacillus velezensis TCS001 suspension concentrate was diluted with sterile water to the corresponding concentration, and then root irrigation and spray treatments were performed respectively.

The potting soil was sterilized by dry heat in an oven at 160° C. for 2 h, and each pot contained 960 g of sterile soil.

Root irrigation: After the strawberry seedlings were transplanted, each plant was subjected to root irrigation with 100 mL of 300× diluted Bacillus velezensis TCS001 suspension concentrate. Each treatment had 5 pot replicates.

Spray: the first spray treatment was performed after the strawberry seedlings were transplanted. A spray treatment of 5 mL per plant was performed every 7 days (1, 2, 3 times). Each treatment had 5 pot replicates. The spray pressure was 0.1 MPa. Determination of Growth Indicators

### Determination of Morphological Indicators of Strawberries

The basic morphological indicators (plant height) of strawberries treated with the Bacillus velezensis TCS001 suspension concentrate (at 14 d, 21 d, and 28 d) were measured using a graduated ruler (scale division 1 mm). For each treatment, 5 plants with consistent growth were selected for measurement.

### Determination of Chlorophyll Content in Strawberry Leaves

The relative chlorophyll content (SPAD) of the second expanded leaf outside the central leaf of a strawberry plant after treatment with the TCS001 suspension concentrate (at 14 d, 21 d, and 28 d) was measured using a chlorophyll meter (Zhejiang Top Cloud-Agri Technology Co., Ltd.). For each treatment, 5 plants with consistent growth were selected for measurement.

### Determination of Fresh Weight of Strawberry Roots and Leaves

The strawberry plants treated with the TCS001 suspension concentrate (at 14 d, 21 d, and 28 d) were blotted dry with paper towels and then weighed using an electronic balance to determine their fresh weights of roots and leaves. The fresh weight of roots and leaves of a single strawberry plant was taken as one replicate, and each treatment had 5 replicates.

### Determination of the Number of Leaves per Strawberry Plant

The number of leaves per strawberry plant treated with the TCS001 suspension concentrate (at 14 d, 21 d, and 28 d) was determined. The number of leaves of a single strawberry plant was taken as one replicate, and each treatment had 5 replicates.

### Determination of Strawberry Leaf Area

The leaf area of strawberries at 28 d after treatment with the TCS001 suspension concentrate was measured using a leaf area meter (Zhejiang Top Cloud-Agri Technology Co., Ltd.). The third expanded leaf outside the central leaf of a strawberry plant was taken for leaf measurement. Each treatment had 5 replicates.

### Enzyme Activities and Endogenous Hormones

After spray treatments (1, 2, and 3 times) and subsequent cultivation for 7 days, root length, plant height, fresh and dry weights of stems and leaves, and chlorophyll content were determined. Leaf peroxidase (POD), superoxide dismutase (SOD), and catalase (CAT) enzyme activities were determined using corresponding enzyme-linked immunosorbent assay (ELISA) kits. The contents of abscisic acid (ABA), indole-3-acetic acid (IAA), and gibberellin (GA) in strawberry leaves were determined using corresponding ELISA kits.

Use of the Bacillus velezensis TCS001 Suspension Concentrate in Facility-cultivated Tomatoes

### Test Design

Three treatment groups were set up in this test:
Group A: Bacillus velezensis TCS001 treatment group;
Group B: chemical agent treatment group;
Group C: blank control group (no agent treatment).

Each treatment area was 200 m². The treatment protocols for Groups A and B are shown in the table below.

TABLE 6
Treatment Protocol for Tomato Group A

| Application | | | Application |
|---|---|---|---|
| Stage | Agent | Amount | Method |
| Seedling | 1 × 10⁹ CFU/mL TCS001 suspension | 500x dilution | Nursery bed |
| raising stage | concentrate | | drenching, |
| | | | applied once |
| Day of | 1 × 10⁹ CFU/mL TCS001 suspension | 500x dilution | Root irrigation, |
| transplanting | concentrate | | applied once |
| | | | with the |
| | | | settling water |
| Seedling stage | 1 × 10⁹ CFU/mL TCS001 suspension | 500x dilution | Spray |
| | concentrate | | treatment, |
| | 2% amino-oligosaccharide aqueous solution | 160 mL/mu | applied twice |
| Flowering | 1 × 10⁹ CFU/mL TCS001 suspension | 500x dilution | Spray |
| stage | concentrate | | treatment, |
| | | | applied twice |
| Fruiting stage | 1 × 10⁹ CFU/mL TCS001 suspension | 500x dilution | Spray |
| | concentrate | | treatment, |
| | | | applied twice |

TABLE 7
Treatment Protocol for Tomato Group B

| Application | | | | Application |
|---|---|---|---|---|
| Stage | Agent | Amount | | Method |
| Seedling | 60% sulfur fenaminosulf wettable powder | 8 | g/m² | Nursery bed |
| raising stage | | | | broadcasting, |
| | | | | applied once |
| Day of | 3% zhongshengmycin wettable powder | 800x dilution | | Root irrigation, |
| transplanting | | | | applied once with |
| | | | | the settling water |
| Seedling stage | 2% amino-oligosaccharide aqueous | 160 | mL/mu | Spray treatment, |
| | solution | | | applied twice |
| | 75% chlorothalonil water dispersible | 100 | g/mu | |
| | granules | | | |
| | 3% zhongshengmycin wettable powder | 800x dilution | | Root irrigation, |
| | | | | applied once |
| Flowering | 40% pyrimethanil suspension concentrate | 70 | mL/mu | Spray treatment, |
| stage | | | | applied twice |
| Fruiting stage | 75% chlorothalonil water dispersible | 100 | g/mu | Spray treatment, |
| | granules | | | applied twice |
| | 40% pyrimethanil suspension concentrate | 70 | mL/mu | |

### Investigation of Control Efficacy Against Diseases

### Investigation of Control Efficacy Against Damping-Off in Tomatoes

After seedling emergence, when obvious disease symptoms appeared in the blank control group, the seedling mortality rate was examined, and the control efficacy was calculated. Three nursery trays were selected for investigation per treatment.

$$Control efficacy ( \% ) = \frac{Control seedling mortality rate - Treatment seedling mortality rate}{Control seedling mortality rate} \times 100$$

Investigation of Control Efficacy against Bacterial Wilt in Tomatoes

When obvious bacterial wilt symptoms appeared in the blank control group, the control efficacy against bacterial wilt in tomatoes was investigated. According to the method of NY/T 1464.32-2010 Pesticide guidelines for the field efficacy trials—Part 32: Fungicides against southern bacterial wilt of tomato, four random points were sampled per treatment, with 8 m² investigated per point. The total number of tomato plants and the number of diseased plants were recorded respectively. The disease incidence rate and control efficacy were calculated.

$$Control efficacy ( \% ) = \frac{Control disease incidence rate - Treatment disease incidence rate}{Control disease incidence rate} \times 100$$

Investigation of Control Efficacy against Early Blight in Tomatoes

When obvious early blight symptoms appeared in the blank control group, the control efficacy against early blight in tomatoes was investigated. According to the method of GB/T 17980.31-2000 Pesticide—Guidelines for the field efficacy trials (I)—Fungicides against early and late blight of tomato, five random points were sampled per treatment, with 2 plants investigated per point. For each plant, 10 leaves were investigated from the upper, middle, and lower parts. Grading was performed based on the percentage of lesion area on each leaf relative to the total leaf area.

### Leaf Grading Method:

Grade 0: no lesion;
Grade 1: lesion area accounting for less than 5% of the total leaf area;
Grade 3: lesion area accounting for 6%-10% of the total leaf area;
Grade 5: lesion area accounting for 11%-20% of the total leaf area;
Grade 7: lesion area accounting for 21%-50% of the total leaf area; and
Grade 9: lesion area accounting for more than 50% of the total leaf area.

Based on the investigation results, the disease index and control efficacy were calculated by the following formulas.

$$Disease index = \frac{\begin{matrix}\sum Number of diseased leaves at \\ each grade \times Relative grade value\end{matrix}}{Total number of leaves investigated \times 9} \times 100$$

$$Control efficacy ( \% ) = \times \frac{Disease index in control area - Disease index in treatment area}{Disease index in control area} \times 100$$

### Investigation of Control Efficacy Against Gray Mold in Tomatoes

When obvious gray mold symptoms appeared in the blank control group, the control efficacy against gray mold was investigated. According to the method of GB/T 17980.28-2000 Pesticide—Guidelines for the field efficacy trials (I)—Fungicides against gray mold of vegetables, five points were sampled per treatment, with 2 plants investigated per point. All fruits of each plant were investigated. The disease incidence was calculated, and records were made according to the following grading method.

### Fruit Grading Method:

Grade 0: no lesion;
Grade 1: lesions on residual petals or stylar infection;
Grade 3: sepal rot or stylar infection spreading to the fruit navel;
Grade 5: soaking spots on the fruit navel without a mycelial layer;
Grade 7: mycelial layer on the fruit navel but not spreading to other parts; and
Grade 9: mycelial layer spreading to other parts of the fruit.

Based on the investigation results, the disease index and control efficacy were calculated by the following formulas.

$$Disease index = \frac{\begin{matrix}\sum Number of diseased leaves ( fruits ) at \\ each grade \times Relative grade value\end{matrix}}{Total number of leaves ( fruits ) investigated \times 9} \times 100$$

$$Control efficacy ( \% ) = \frac{Disease index in control area - Disease index in treatment area}{Disease index in control area} \times 100$$

### Investigation of Control Efficacy Against Fusarium Wilt in Tomatoes

When obvious Fusarium wilt symptoms appeared in the blank control group, the control efficacy against Fusarium wilt was investigated. According to the method of GB/T 17980.113-2004 Pesticide—Guidelines for the field efficacy trials (II)—Part 113: Fungicides against Fusarium wilt of cucurbits, four random points were sampled per treatment, with 8 m² investigated per point. The total number of tomato plants and the number of diseased plants were recorded respectively. The disease incidence rate and control efficacy were calculated.

$$Control efficacy ( \% ) = \frac{Control disease incidence rate - Treatment disease incidence rate}{Control disease incidence rate} \times 100$$

### Determination of Tomato Biomass

Four random points were sampled per treatment. At each point, 15 consecutive plants were selected, totaling 60 plants. The selected tomato plants were marked with a red thread. At the initial flowering stage of tomatoes, the plant height and stem diameter of the marked tomato plants were measured.

### Determination of Tomato Yield

Starting from the red ripening stage, the ripe fruits of the marked tomato plants were harvested once every 7 days until the end of the pulling stage. The yield per plant was the sum of the weights of the red fruits harvested each time. The number of fruits was recorded at each harvest.

### Determination of Tomato Quality

Vitamin C content was determined according to GB 5009.86-2016 National food safety standard—Determination of ascorbic acid in foods; total acid content was determined according to GB/T 12456-2008 Determination of total acid in foods; soluble sugar content was determined according to GB 5009.8-2016 National food safety standard—Determination of fructose, glucose, sucrose, maltose, and lactose in foods; and protein content was determined according to GB 5009.9-2016 National food safety standard—Determination of starch in foods.

Use of the Bacillus velezensis TCS001 Suspension Concentrate in Facility-Cultivated Cucumbers

### Test Design

Three treatment groups were setup in this test: Group A was the Bacillus velezensis TCS001 treatment group; Group B was the chemical agent treatment group; Group C was the blank control group (no agent treatment). Each treatment area was 200 m². The treatment protocols for Groups A and B are shown in the table below.

TABLE 8
Treatment Protocol for Cucumber Group A

| Application | | | Application |
|---|---|---|---|
| Stage | Agent | Amount | Method |
| Seedling | 1 × 10⁹ CFU/mL TCS001 suspension | 500x dilution | Nursery bed |
| raising stage | concentrate | | drenching, applied |
| | | | once |
| Day of | 1 × 10⁹ CFU/mL TCS001 suspension | 500x dilution | Root irrigation, |
| transplanting | concentrate | | applied once with |
| | | | the settling water |
| Planting stage | 1 × 10⁹ CFU/mL TCS001 suspension | 500x dilution | Spray treatment, |
| | concentrate | | applied twice |
| | 2% amino-oligosaccharide aqueous solution | 160 mL/mu | |
| Vining stage | 1 × 10⁹ CFU/mL TCS001 suspension | 500x dilution | Spray treatment, |
| | concentrate | | applied once |
| | 2% amino-oligosaccharide aqueous solution | 160 mL/mu | |
| Fruiting stage | 1 × 10⁹ CFU/mL TCS001 suspension | 500x dilution | Spray treatment, |
| | concentrate | | applied once |

TABLE 9
Treatment Protocol for Cucumber Group B

| Application | | | | Application |
|---|---|---|---|---|
| Stage | Agent | Amount | | Method |
| Seedling | 66.5% propamocarb hydrochloride | 5 | g/m² | Nursery bed |
| raising stage | aqueous solution | | | drenching, applied |
| | | | | once |
| Day of | 3% zhongshengmycin wettable | 800x dilution | | Root irrigation, |
| transplanting | powder | | | applied once with the |
| | | | | settling water |
| Planting stage | 2% amino-oligosaccharide aqueous | 160 | mL/mu | Spray treatment, |
| | solution | | | applied twice |
| | 5% zhongshengmycin wettable | 50 | g/mu | |
| | powder | | | |
| Vining stage | 2% amino-oligosaccharide aqueous | 160 | mL/mu | Spray treatment, |
| | solution | | | applied once |
| | 430 g/L tebuconazole suspension | 15 | mL/mu | |
| | concentrate | | | |
| | 40% dimethomorph suspension | 40 | mL/mu | |
| | concentrate | | | |
| Flowering and | 430 g/L tebuconazole suspension | 15 | mL/mu | Spray treatment, |
| fruiting stages | concentrate | | | applied once |
| | 40% dimethomorph suspension | 40 | mL/mu | |
| | concentrate | | | |

### Investigation of Control Efficacy Against Damping-Off in Cucumbers

After seedling emergence, when obvious disease symptoms appeared in the blank control group, the seedling mortality rate was examined, and the control efficacy was calculated. Three nursery trays were selected for investigation per treatment.

$$Control efficacy ( \% ) = \frac{Control seedling mortality rate - Treatment seedling mortality rate}{Control seedling mortality rate} \times 100$$

### Investigation of Control Efficacy Against Bacterial Angular Leaf Spot in Cucumbers

When obvious angular leaf spot symptoms appeared in the blank control group, the control efficacy against angular leaf spot was investigated. The investigation was performed according to the provisions of GB/T 17980.110-2004 Pesticide Guidelines for the field efficacy trials (HI) Part 110: Fungicides against bacterial angular leaf spot of cucumber. Three sampling points were taken per treatment, with 5 plants investigated per point. All leaves of each plant were investigated. Grading was performed based on the percentage of lesion area on each leaf relative to the total leaf area.

### Grading Method:

Grade 0: no lesion;
Grade 1: lesions accounting for less than 5% of the total leaf area;
Grade 3: lesions accounting for 6%-10% of the total leaf area;
Grade 5: lesions accounting for less than 11%-20% of the total leaf area;
Grade 7: lesions accounting for less than 21%-50% of the total leaf area; and
Grade 9: lesions accounting for more than 51% of the total leaf area.

Based on the investigation results, the disease index and control efficacy were calculated by the following formulas.

$$Disease index = \frac{\begin{matrix}\sum Number of diseased leaves at \\ each grade \times Relative grade value\end{matrix}}{Total number of leaves investigated \times 9} \times 100$$

$$Control efficacy ( \% ) = \frac{Disease index in control area - Disease index in treatment area}{Disease index in control area} \times 100$$

### Investigation of Control Efficacy Against Powdery Mildew in Cucumbers

When obvious powdery mildew symptoms appeared in the blank control group, the control efficacy against powdery mildew was investigated. The investigation was performed according to the provisions of GB-T 17980.30-2000 Pesticide—Guidelines for the field efficacy trials (I)—Fungicides against cucumber powdery mildew. Five random points were sampled per treatment, with 2 plants investigated per point. All leaves of each plant were investigated. Grading was performed based on the percentage of lesion area on each leaf relative to the total leaf area, and the disease index and control efficacy were calculated.

### Grading Method (Based on a Leaf as a Unit):

Grade 0: no lesion;
Grade 1: lesions accounting for less than 5% of the total leaf area;
Grade 3: lesions accounting for 6%-10% of the total leaf area;
Grade 5: lesions accounting for less than 11%-20% of the total leaf area;
Grade 7: lesions accounting for less than 21%-40% of the total leaf area; and
Grade 9: lesions accounting for more than 40% of the total leaf area.

Based on the investigation results, the disease index and control efficacy were calculated by the following formulas.

$$Disease index = \frac{\begin{matrix}\sum Number of diseased leaves at \\ each grade \times Relative grade value\end{matrix}}{Total number of leaves investigated \times 9} \times 100$$

$$Control efficacy ( \% ) = \frac{Disease index in control area - Disease index in treatment area}{Disease index in control area} \times 100$$

### Investigation of Control Efficacy Against Downy Mildew in Cucumbers

When obvious downy mildew symptoms appeared in the blank control group, the control efficacy against downy mildew was investigated. The investigation was performed according to the provisions of GB-T 17980.26-2000 Pesticide—Guidelines for the field efficacy trials (I) Fungicides against downy mildew of cucumber. Five random points were sampled per plot, with 3 plants investigated per point. For each plant, 10 leaves were investigated. Grading was performed based on the percentage of lesion area on each leaf relative to the total leaf area.

### Grading Method (Based on a Leaf as a Unit):

Grade 0: no lesion;
Grade 1: lesion area accounting for less than 5% of the total leaf area;
Grade 3: lesion area accounting for 6%-10% of the total leaf area;
Grade 5: lesion area accounting for 11%-20% of the total leaf area;
Grade 7: lesion area accounting for 21%-50% of the total leaf area; and
Grade 9: lesion area accounting for more than 50% of the total leaf area.

Based on the investigation results, the disease index and control efficacy were calculated by the following formulas.

$$Disease index = \frac{\begin{matrix}\sum Number of diseased leaves at \\ each grade \times Relative grade value\end{matrix}}{Total number of leaves investigated \times 9} \times 100$$

$$Control efficacy ( \% ) = \frac{Disease index in control area - Disease index in treatment area}{Disease index in control area} \times 100$$

### Investigation of Control Efficacy Against Fusarium Wilt in Cucumbers

When obvious Fusarium wilt symptoms appeared in the blank control group, the control efficacy against Fusarium wilt was investigated. According to the method of GB/T 17980.113-2004 Pesticide—Guidelines for the field efficacy trials (II) Part 113: Fungicides against Fusarium wilt of cucurbits, four random points were sampled per treatment, with 8 m² investigated per point. The total number of cucumber plants and the number of diseased plants were recorded respectively. The disease incidence rate and control efficacy were calculated.

$$Control efficacy ( \% ) = \frac{Control disease incidence rate - Treatment disease incidence rate}{Control disease incidence rate} \times 100$$

### Determination of Cucumber Biomass

Four random points were sampled per treatment. At each point, 15 consecutive plants were selected, totaling 60 plants. The selected plants were marked with a red thread. At the initial flowering stage, the stem diameter of the cucumber plants was measured, and the relative chlorophyll content of the fourth leaf from the top was measured using a handheld chlorophyll meter TYS-A.

### Determination of Cucumber Yield

After fruit ripening, cucumber fruits with a diameter between 3 cm and 4 cm from each treatment were collected periodically. Collection was performed 8 consecutive times, and the cumulative yield of cucumbers was calculated.

### Determination of Cucumber Quality

Vitamin C content was determined according to GB 5009.86-2016 National food safety standard—Determination of ascorbic acid in foods; moisture content was determined according to GB 5009.3-2016 Determination of moisture in foods; and soluble solids content was determined according to NY-T 2637-2014 Refractometric method for determination of total soluble solids in fruits and vegetables.

### Test Results

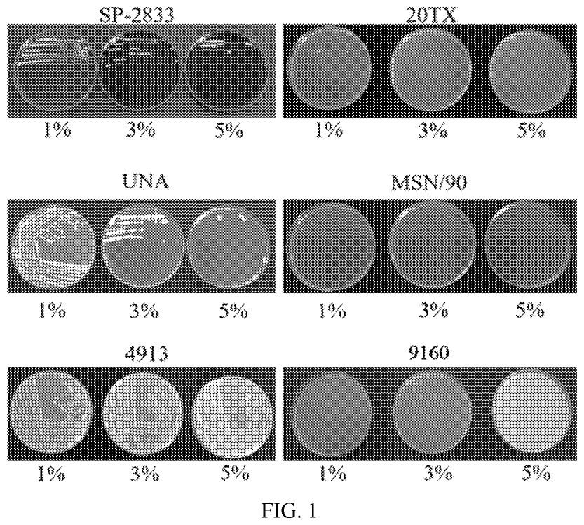

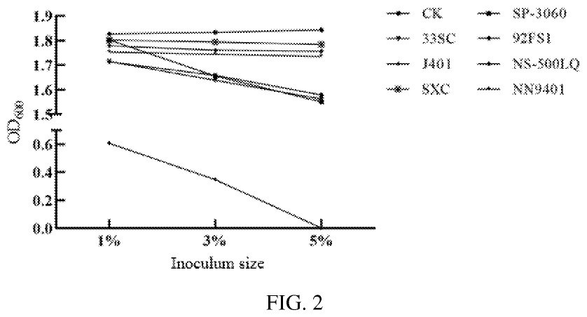

From the biocompatibility test results shown in FIGS. 1 and 2, it can be seen that Bacillus velezensis TCS001 grew well in SXC, 4913, UNA, NN9401, and NS-500LQ. For the remaining wetting and dispersing agents, inhibition of Bacillus velezensis TCS001 growth appeared as the concentration increased. Therefore, the five wetting and dispersing agents with good compatibility were subjected to the next step of re-screening.

TABLE 10
Re-screening Results of Wetting and Dispersing Agents

| Product Name | Ratio (%) | Suspension Rate (%) |
|---|---|---|
| SXC | 1 | 72 |
| | 3 | 79 |
| | 6 | 84 |
| 4913 | 1 | 61 |
| | 3 | 65 |
| | 6 | 68 |
| UNA | 1 | 74 |
| | 3 | 78 |
| | 6 | 80 |
| NN9401 | 1 | 69 |
| | 3 | 72 |
| | 6 | 75 |
| NS-500LQ | 1 | 59 |
| | 3 | 61 |
| | 6 | 64 |

It can be seen from Table 10 that the suspension rates of SXC, UNA, and NN9401 were higher than those of 4913 and NS-500LQ, but all were below 90%. Therefore, the next step of testing in pairwise combinations was conducted to increase the suspension rate. From the combination screening results shown in Table 11, it can be seen that the suspension rate reached its highest when the optimal ratio of wetting and dispersing agents was SXC+UNA at 3%+3%.

TABLE 11
Screening Results of Wetting and Dispersing Agent Combinations

| Product Name | Ratio (%) | Suspension Rate (%) |
|---|---|---|
| SXC | 6 | 84 |
| UNA | 6 | 80 |
| NN9401 | 6 | 75 |
| SXC + 9401 | 3 + 3 | 88 |
| SXC + UNA | 3 + 3 | 96 |
| NN9401 + UNA | 3 + 3 | 91 |

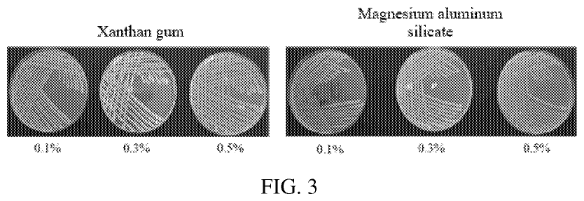

It can be seen from FIG. 3 that although magnesium aluminum silicate did not inhibit the growth of Bacillus velezensis TCS001 as the concentration increased, it was difficult to dissolve in the culture medium, and small clumping phenomena appeared. In contrast, xanthan gum did not exhibit this phenomenon and did not inhibit the growth of Bacillus velezensis TCS001. Therefore, xanthan gum was selected as the thickener. It can be seen from Table 12 that the optimal concentration of the thickener xanthan gum was 0.15%.

TABLE 12
Screening Results of the Addition
Amount of Thickener Xanthan Gum

| | Water Separation after 1 | |
|---|---|---|
| Ratio (%) | Month at Room Temperature (%) | Viscosity (CPS) |
| 0.05 | 50 | 210 |
| 0.08 | 28 | 354 |
| 0.1 | 15 | 422 |
| 0.12 | 5 | 532 |
| 0.15 | No water separation | 608 |
| 3 + 3 | No water separation | 960 |

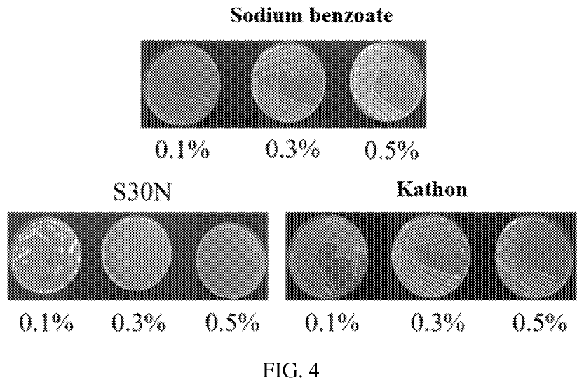

It can be seen from FIG. 4 that S30N inhibited the growth of Bacillus velezensis TCS001. Therefore, Kathon and sodium benzoate were selected as preservatives for the next step of testing.

It can be seen from Table 13 that the suspension rate reached its highest and the moldiness rate was the lowest when the optimal ratio of Kathon and sodium benzoate was 0.2%+0.2%.

TABLE 13
Efficacy of Preservatives

| | Sodium | | Sodium | Suspension | Suspension | |
|---|---|---|---|---|---|---|
| | Benzoate | Kathon | Benzoate + Kathon | Rate Before | Rate After | Moldiness |
| Sample | (%) | (%) | (%) | Storage | Storage | Rate |
| 1 | 0.1 | | | 93.3 | 60.1 | +++ |
| 2 | 0.2 | | | 93.6 | 62.3 | +++ |
| 3 | 0.3 | | | 92.9 | 61.5 | +++ |
| 4 | | 0.1 | | 93.4 | 50.9 | +++ |
| 5 | | 0.2 | | 93.6 | 52.6 | +++ |
| 6 | | 0.3 | | 93.8 | 55.7 | +++ |
| 7 | | | 0.1 + 0.3 | 93.7 | 82.3 | ++ |
| 8 | | | 0.2 + 0.2 | 93.9 | 86.7 | − |
| 9 | | | 0.3 + 0.1 | 92.7 | 83.1 | + |

Based on the optimization results of the adjuvants including the wetting and dispersing agents, thickener, and preservatives, Table 14 shows the optimal formulation of the Bacillus velezensis TCS001 suspension concentrate.

TABLE 14
Formulation of 3.9 × 10⁹ CFU/mL Bacillus velezensis
TCS001 Suspension Concentrate

| Raw Material | Material Ratio |
|---|---|
| Bacillus velezensis TCS001 fermentation broth | 40% |
| Wetting and dispersing agent SXC | 3% |
| Wetting and dispersing agent UNA | 3% |
| Thickener xanthan gum | 0.15% |
| Preservative Kathon | 0.2% |
| Preservative sodium benzoate | 0.2% |
| Water | 53.45% |

Table 15 shows the performance indicator measurement results of the 3.9×10⁹ CFU/mL Bacillus velezensis TCS001 suspension concentrate. All performance indicators met the qualified standards.

TABLE 15
Performance Test Results of 3.9 × 10⁹ CFU/mL
Bacillus velezensis TCS001 Suspension Concentrate

| Test Item | Standard Value | Measured Value | Conclusion |
|---|---|---|---|
| Appearance | Brown flowable | Brown flowable | Qualified |
| | liquid suspension | liquid suspension | |
| | easy to measure | easy to measure | |
| | volume | volume | |
| Bacillus velezensis content (CFU/mL) | ≥1.0 × 10⁹ | 3.9 × 10⁹ | Qualified |
| Contamination rate (%) | ≤5.0 | 3.4 | Qualified |
| pH value range | 5.0-8.0 | 6.8 | Qualified |
| Suspension rate of Bacillus | ≥80 | 88.3 | Qualified |
| velezensis (%) | | | |
| Wet sieving (%) | ≥98 | 99.3 | Qualified |
| Residue after pouring (%) | ≤5.0 | 0.3 | Qualified |
| Residue after washing (%) | ≤0.5 | 0.2 | Qualified |
| Persistent foaming property, | ≤60 | 16 | Qualified |
| after 1 min (mL) | | | |

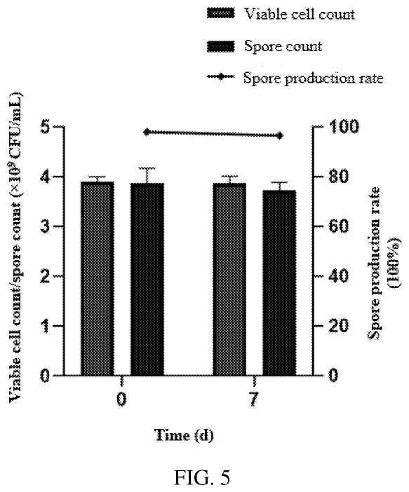

It can be seen from FIG. 5 that the viable cell count of the 3.9×10⁹ CFU/mL Bacillus velezensis TCS001 suspension concentrate of this disclosure decreased from 3.9×10⁹ CFU/mL to 3.86×10⁹ CFU/mL after 14 days of storage at low temperature (0° C.), and the active ingredient after storage was almost not reduced compared to that before storage, indicating that it is stable under storage at 0° C.

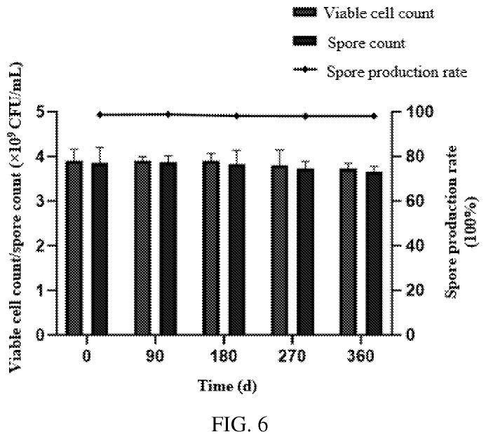

It can be seen from FIG. 6 that the viable cell count of the 3.9×10⁹ CFU/mL Bacillus velezensis TCS001 suspension concentrate of this disclosure decreased from 3.9×10⁹ CFU/mL to 3.73×10⁹ CFU/mL after 360 days of storage at low temperature (4° C.), and the active ingredient after storage was reduced by only 4.3% compared to that before storage, indicating that it is stable under storage at 4° C.

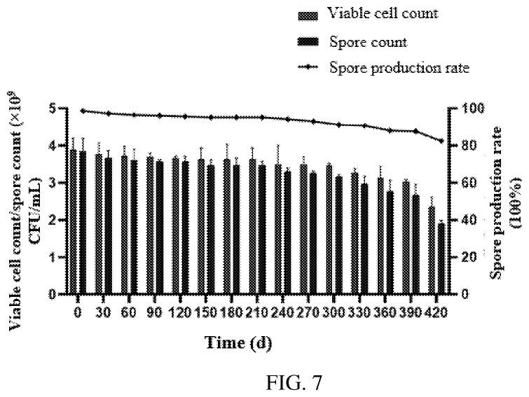

It can be seen from FIG. 7 that the viable cell count of the 3.9×10⁹ CFU/mL Bacillus velezensis TCS001 suspension concentrate of this disclosure decreased from 3.9×10⁹ CFU/mL to 2.36×10⁹ CFU/mL after 420 days of storage at normal temperature (28° C.), and the active ingredient after storage was reduced by 39.4% compared to that before storage, indicating that it is unstable under storage at 28° C.

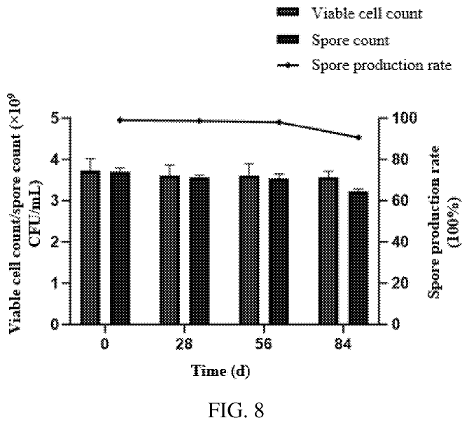

It can be seen from FIG. 8 that the viable cell count of the 3.9×10⁹ CFU/mL Bacillus velezensis TCS001 suspension concentrate of this disclosure decreased from 3.73×10⁹ CFU/mL to 3.56×10⁹ CFU/mL after 84 days of storage at high temperature (35° C.), and the active ingredient after storage was reduced by 4.5% compared to that before storage, indicating that it is stable under storage at 35° C.

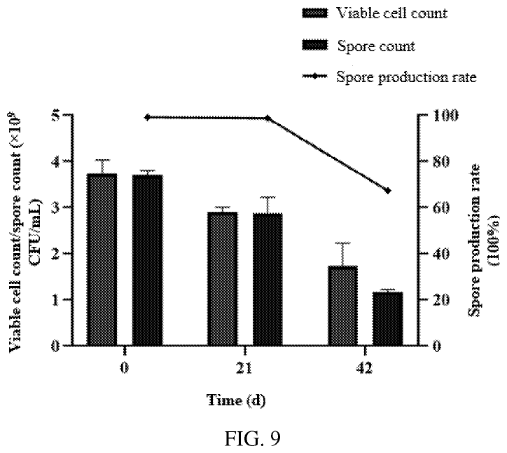

It can be seen from FIG. 9 that the viable cell count of the 3.9×10⁹ CFU/mL Bacillus velezensis TCS001 suspension concentrate of this disclosure decreased from 3.73×10⁹ CFU/mL to 1.73×10⁹ CFU/mL after 42 days of storage at high temperature (45° C.), and the active ingredient after storage was reduced by 53.6% compared to that before storage, indicating that it is unstable under storage at 45° C.

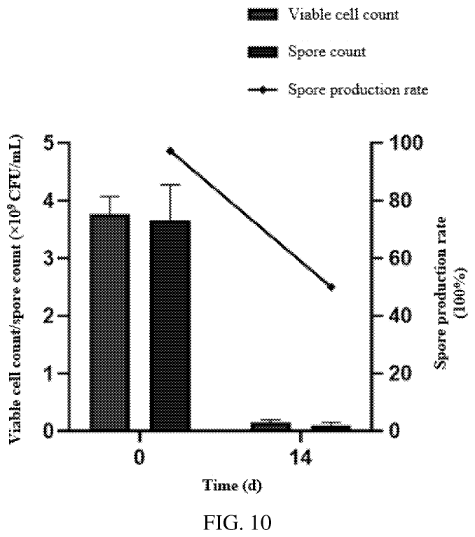

It can be seen from FIG. 10 that the viable cell count of the 3.9×10⁹ CFU/mL Bacillus velezensis TCS001 suspension concentrate of this disclosure decreased from 3.76×10⁹ CFU/mL to 0.15×10⁹ CFU/mL after 14 days of storage at high temperature (54° C.), and the active ingredient after storage was reduced by 96% compared to that before storage, indicating that it is unstable under storage at 54° C.

It can be seen from Table 16 that applying the Bacillus velezensis TCS001 suspension concentrate 400×-diluted for spray treatment, once each at the flower bud differentiation stage, initial flowering stage, and full bloom stage of cherries, and once per week from the young fruit stage to the harvest stage, resulted in an increase of β-carotene by 13.6%, an increase of anthocyanins by 9.8%, an increase of soluble sugars by 730, a decrease of vitamin C by 19.4%, and a decrease of total acid by 7% in the cherries.

TABLE 16
Quality Determination Results of Cherries

| | Measured Value | | |
|---|---|---|---|
| | of TCS001 | | |
| | Suspension | | |
| | Concentrate | Blank | |
| Test Item | Treatment | Control | Test Method |
| Soluble sugar (g/100 g) | 8.8 | 8.2 | NY/T 2742-2015 |
| Total acid (g/kg) | 5.44 | 5.85 | GB 12456-2021 |
| Soluble solids (%) | 11.8 | 10.9 | NY/T 2637-2014 |
| Vitamin C (ascorbic | 9.35 | 11.6 | GB 5009.86-2016 |
| acid) (mg/100 g) | | | |
| β-carotene | 142 | 125 | GB 5009.83-2016 |
| Anthocyanins (mg/g) | 1.23 | 1.12 | T/QAS 075-2022 |

It can be seen from Table 17 that applying the Bacillus velezensis TCS001 suspension concentrate 500×-diluted for root irrigation treatment, once each at the flower bud differentiation stage, initial flowering stage, and full bloom stage of blueberries, and once per week from the young fruit stage to the harvest stage, resulted in an increase of anthocyanins by 10%, an increase of soluble sugars by 40%, an increase of vitamin C by 50%, and a decrease of total acid by 200% in the blueberries.

TABLE 17
Quality Determination Results of Blueberries

| | Measured Value | | |
|---|---|---|---|
| | of TCS001 | Blank | |
| Test Item | Treatment | Control | Test Method |
| Soluble sugar (g/100 g) | 9.9 | 9.5 | NY/T 2742-2015 |
| Total acid (g/kg) | 3.07 | 3.88 | GB 12456-2021 |
| Soluble solids (%) | 10.6 | 11.3 | NY/T 2637-2014 |
| Vitamin C (ascorbic | 11.6 | 11.0 | GB 5009.86-2016 |
| acid) (mg/100 g) | | | |
| Anthocyanins (mg/g) | 1.19 | 1.08 | T/QAS 075-2022 |

During the test, it was observed that Bacillus velezensis TCS001 had a positive effect on the color, size, glossiness, and other traits of the blueberries. Five groups of people tasted the fruits and reported good palatability. The results are shown in Table 18 below.

TABLE 18
Tasting Results of Blueberries

| | Group I | | | Group II | | | Group III | |
|---|---|---|---|---|---|---|---|---|
| Treatment | Hardness | Acidity | Sweetness | Hardness | Acidity | Sweetness | Hardness | Acidity |
| TCS001- | 4 | 3 | 3 | 3 | 3 | 4 | 4 | 3 |
| 500x | | | | | | | | |
| CK | 3 | 4 | 3 | 2 | 4 | 3 | 2 | 3 |

| | Group III | Group IV | | | Group V | | |
|---|---|---|---|---|---|---|---|
| Treatment | Sweetness | Hardness | Acidity | Sweetness | Hardness | Acidity | Sweetness |
| TCS001- | 3 | 4 | 3 | 3 | 4 | 3 | 4 |
| 500x | | | | | | | |
| CK | 2 | 2 | 3 | 2 | 4 | 3 | 2 |

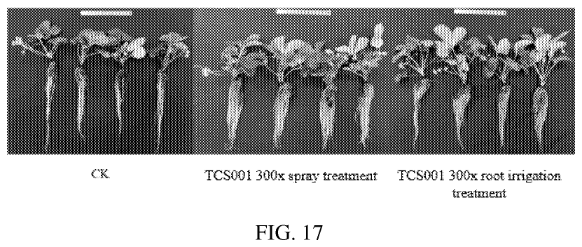

The plants after spray and root irrigation treatment with the Bacillus velezensis TCS001 suspension concentrate at a 300× dilution are shown in FIG. 17.

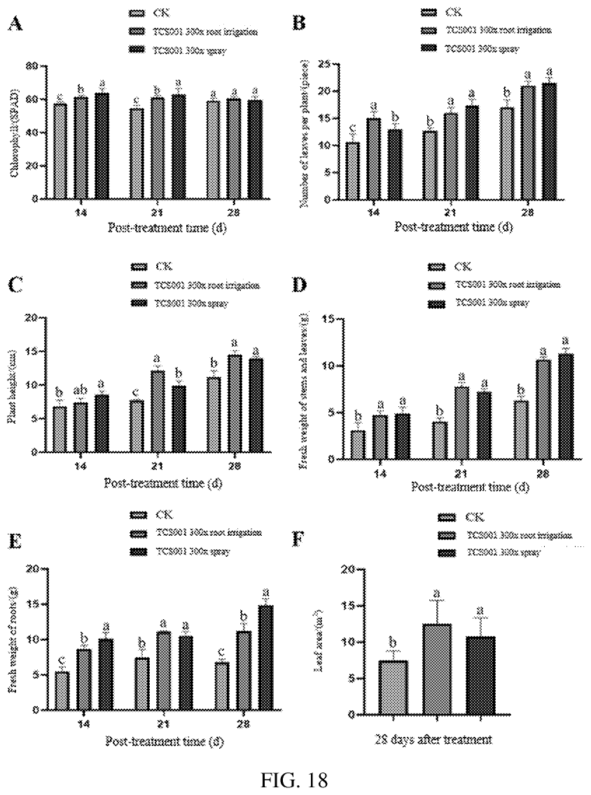

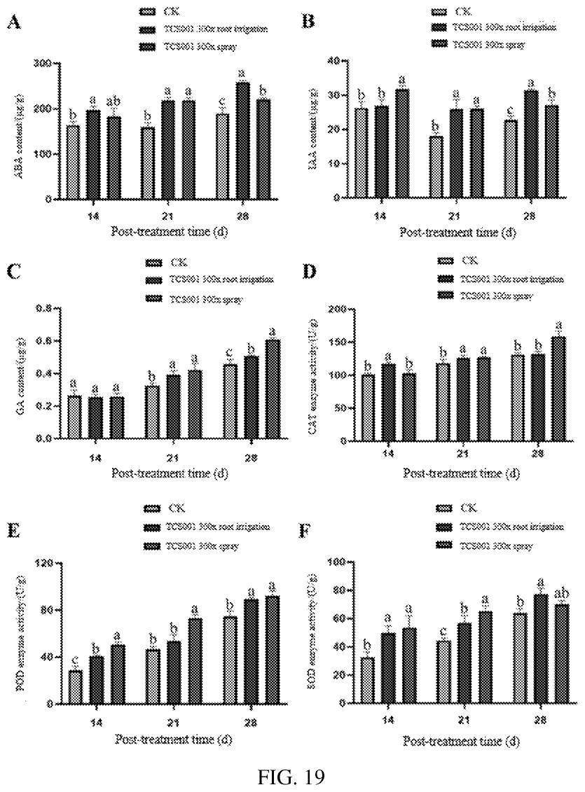

The growth indicator measurement results are shown in FIGS. 18 and 19.

It can be seen from FIG. 18 that after spray treatment with the Bacillus velezensis TCS001 suspension concentrate at a 300× dilution, the chlorophyll concentration in strawberry leaves reached its highest at 14 d and 21 d, increasing by 11% and 14.89% respectively compared with CK, and the number of leaves per plant, fresh weight of stems and leaves, and fresh weight of roots at 28 d increased by 26.5%, 79.4%, and 120% respectively compared with CK.

After root irrigation treatment with the Bacillus velezensis TCS001 suspension concentrate at a 300× dilution, compared with CK, the leaf area and plant height of strawberries at 28 d increased by 68.41% and 29.68%, respectively.

### Results of Endogenous Hormone and Enzyme Activity Determination

It can be seen from FIG. 19 that after root irrigation treatment with the Bacillus velezensis TCS001 suspension concentrate at a 300× dilution, compared with CK, the leaf IAA content, ABA content, and SOD activity of strawberries at 28 d increased by 38.47%, 36.04%, and 21.41%, respectively.

After spray treatment with the Bacillus velezensis TCS001 suspension concentrate at a 300× dilution, compared with CK, the leaf GA content, CAT activity, and POD activity of strawberries at 28 d increased by 34.04%, 21.23%, and 23.21%, respectively.

Effect of the Bacillus velezensis TCS001 Suspension Concentrate on Facility-Cultivated Tomatoes

TABLE 19
Control Efficacy Against Full-Cycle Diseases in Tomatoes

| Treatment | Damping- | Bacterial | Early | Gray | Fusarium |
|---|---|---|---|---|---|
| No. | off (%) | Wilt (%) | Blight (%) | Mold (%) | Wilt (%) |
| A | 79.78 | 78.94 | 80.34 | 81.29 | 79.79 |
| B | 71.66 | 72.24 | 70.57 | 74.33 | 76.03 |
| C | — | — | — | — | — |

It can be seen from Table 19 that the full-cycle application of the Bacillus velezensis TCS001 suspension concentrate provided good control efficacy against major diseases in the growth cycle of facility-cultivated tomatoes, including damping-off, bacterial wilt, early blight, gray mold, and Fusarium wilt, which was superior to conventional chemical agents.

TABLE 20
Test Results of Quality Improvement Throughout the Growth Cycle of Tomatoes

| | | | Average | Average | | Vitamin | | |
|---|---|---|---|---|---|---|---|---|
| | Plant | Stem | Weight | Yield | Soluble | C | Soluble | Titratable Acid |
| | Height | Diameter | per | per Plant | Solids | (mg/100 | Sugar | (as citric acid) |
| Treatment | (cm) | (cm) | Fruit (g) | (kg) | (%) | g) | (g/100 g) | (g/kg) |
| A | 62.05 | 4.01 | 185.4 | 2.16 | 4.6 | 17.4 | 2.8 | 2.32 |
| B | 58.08 | 3.90 | 173.2 | 1.90 | 4.2 | 16.0 | 2.6 | 2.88 |
| C | 58.70 | 3.73 | 174.4 | 1.99 | 4.3 | 15.8 | 2.5 | 2.76 |

It can be seen from Table 20 that applying the TCS001 microbial agent composition resulted in a significant effect on quality improvement and yield increase for facility-cultivated tomatoes. The biomass of tomatoes increased, the yield was significantly improved, the soluble solids content, vitamin C, and soluble sugar content were all increased, and the titratable acid content was reduced.

Effect of the Bacillus velezensis TCS001 Suspension Concentrate on Facility-Cultivated Cucumbers

TABLE 21
Control Efficacy Against Full-Cycle Diseases in Cucumbers

| | | Bacterial | | | |
|---|---|---|---|---|---|
| Treat- | | Angular | | | |
| ment | Damping- | Leaf | Powdery | Downy | Fusarium |
| No. | off (%) | Spot (%) | Mildew (%) | Mildew (%) | Wilt (%) |
| A | 76.45 | 77.43 | 77.74 | 72.48 | 78.14 |
| B | 74.87 | 78.76 | 75.35 | 71.86 | 76.83 |
| C | — | — | — | — | — |

It can be seen from Table 21 that the full-cycle application of the Bacillus velezensis TCS001 suspension concentrate provided good control efficacy against major diseases in the growth cycle of facility-cultivated cucumbers, including damping-off, bacterial angular leaf spot, powdery mildew, downy mildew, and Fusarium wilt. Except for bacterial angular leaf spot, where the control efficacy was comparable to that of conventional chemical agents, the control efficacy against the remaining diseases was superior to that of chemical agents.

TABLE 22
Test Results of Quality Improvement Throughout the Growth Cycle of Cucumbers

| | Length of | | | | | | | |
|---|---|---|---|---|---|---|---|---|
| | Main | Relative | | | | | Vitamin | |
| | Stem | Chlorophyll | | | Average | | C | Moisture |
| | Base | Content | Number | Weight | Fruit | Soluble | (mg/100 | (g/100 |
| Treatment | (cm) | (SPAD) | (roots) | (kg) | Weight (g) | Solids (%) | g) | g) |
| A | 62.05 | 4.01 | 185.4 | 2.16 | 4.6 | 17.4 | 2.8 | 2.32 |
| B | 58.08 | 3.90 | 173.2 | 1.90 | 4.2 | 16.0 | 2.6 | 2.88 |
| C | 58.70 | 3.73 | 174.4 | 1.99 | 4.3 | 15.8 | 2.5 | 2.76 |

It can be seen from Table 22 that after applying the TCS001 microbial agent composition, the yield of cucumbers was significantly improved, and the vitamin C and moisture contents were both increased, indicating a significant effect of the Bacillus velezensis TCS001 microbial agent composition on quality improvement and yield increase for facility-cultivated cucumbers.

The laboratory where the inventors of this disclosure work had previously developed a wettable powder formulation containing Bacillus velezensis TCS001 as follows: 70% Bacillus velezensis TCS001 fermentation broth, 10% carrier diatomaceous earth, 5% dispersing agent polyvinyl alcohol, 10% wetting agent sodium dodecylbenzenesulfonate, 2.5% stabilizer potassium phosphate, and 2.5% protectant dextrin.

After testing, the wettable powder containing Bacillus velezensis TCS001 of this disclosure had a suspension rate of 80.2% and a wetting time of 20 s, which could meet the requirements for pesticide registration.

However, the wettable powder has drawbacks such as severe loss of secondary metabolites produced by the strains during the development process, and excessive sedimentation and low suspension rate during use, which may lead to easy clogging of sprayer nozzles, uneven concentration of the spray solution, reduced control efficacy, and increased disease incidence. Therefore, the inventors did not consider the wettable powder as a commercially viable formulation.

Compared with the previous powder formulation, the suspension concentrate of this disclosure has no dust hazard and is relatively safe for operators and the environment. Moreover, the suspension concentrate disperses well in water, can be directly used as a spray solution, has good dispersibility, high suspension rate, and relatively strong adhesion to the plant surface, and is resistant to rain erosion. Therefore, its efficacy is more significant and longer-lasting than that of wettable powder, while also possessing the advantages of wettable powder, being wettable by water, and exhibiting even better suspension after dilution with water.

The test results showed that after treatment with the Bacillus velezensis TCS001 suspension concentrate, the quality of cherries and blueberries was significantly improved, early ripening of blueberries was promoted, and the fruits tasted good. Furthermore, it could significantly promote the plant growth of strawberries and induce a faster and stronger protective enzyme system defense response in strawberry leaves. Meanwhile, effective control of diseases was achieved when applied to cucumbers and tomatoes, which was superior to conventional chemical agents, and both yield and quality were improved.

In the foregoing embodiments, the purposes, technical solutions, and beneficial effects of this disclosure are further described in detail. It should be understood that the above merely describes the embodiments of this disclosure and is not intended to limit the scope of protection of this disclosure. Any modifications, equivalent substitutions, or improvements made without departing from the spirit and principle of this disclosure shall fall within the scope of protection of this disclosure.

What is claimed is:

1. A suspension concentrate composition, comprising:
Bacillus velezensis TCS001 fermentation broth, wetting and dispersing agent SXC, wetting and dispersing agent UNA, thickener xanthan gum, preservative Kathon, preservative sodium benzoate, and water,
wherein in the suspension concentrate composition, by weight percentage:
the Bacillus velezensis TCS001 fermentation broth accounts for 10% to 60%,
the SXC and the UNA account for 2% to 10% in total,
the xanthan gum accounts for 0.1% to 1%,
the Kathon and the sodium benzoate account for 0.1% to 0.5% in total,
and the balance is water.

2. The suspension concentrate composition according to claim 1, wherein a mass ratio of the SXC to the UNA is 1:1.

3. The suspension concentrate composition according to claim 1, wherein a mass ratio of the Kathon to the sodium benzoate is 1:1.

4. The suspension concentrate composition according to claim 1, wherein the Bacillus velezensis TCS001 fermentation broth accounts for 40% of a total weight of the composition.

5. The suspension concentrate composition according to claim 1, wherein the SXC and the UNA each account for 3% in the composition.

6. The suspension concentrate composition according to claim 1, wherein the xanthan gum accounts for 0.15% in the composition.

7. The suspension concentrate composition according to claim 1, wherein the Kathon and the sodium benzoate each account for 0.2% in the composition.

8. A method for promoting early ripening of blueberries and improving blueberry fruit quality, comprising applying the suspension concentrate composition according to claim 1 to a blueberry plant or a growing environment thereof.

9. The method according to claim 8, wherein the early ripening refers to ripening 5 to 7 days earlier.

10. The method according to claim 8, wherein an application concentration is a 300× to 700× dilution.

11. The method according to claim 10, wherein the application concentration is a 500× dilution.

12. The method according to claim 8, wherein a method for the application is root irrigation and/or spray treatment.

13. A method for improving cherry fruit quality, comprising applying the suspension concentrate composition according to claim 1 to a cherry plant or a growing environment thereof.

14. The method according to claim 13, wherein the improvement of cherry fruit quality comprises at least one of the following: increasing soluble sugar, increasing soluble solids, increasing anthocyanins, increasing β-carotene, decreasing acidity, improving size, improving glossiness, and improving taste.

15. The method according to claim 13, wherein a method for the application is spray treatment, and an application concentration is a 300× to 700× dilution.
